(19) United States
(12) Patent Application Publication
(10) Pub. No.: US 2021/0132625 A1
(43) Pub. Date: May 6, 2021

(54) MODULAR DELIVERY VEHICLE SYSTEM

(71) Applicant: CARLA R. GILLETT, SACRAMENTO, CA (US)

(72) Inventor: CARLA R. GILLETT, SACRAMENTO, CA (US)

(73) Assignee: Carla R Gillett, Sacramento, CA (US)

(21) Appl. No.: 17/128,055

(22) Filed: Dec. 19, 2020

Related U.S. Application Data
(63) Continuation-in-part of application No. 15/993,609, filed on May 31, 2018, now Pat. No. 10,890,921.

(51) Int. Cl. G05D 1/02; B64C 39/02; B64D 9/00; B64D 27/24; B64D 41/00; B64D 1/08; B64D 47/08; B64D 1/22; G05D 1/00; G05D 1/10

(52) U.S. Cl. CPC G05D 1/0278; G05D 1/0257; B64D 9/003; B64D 27/24; B64D 41/00; B64D 1/08; B64D 47/08; B64D 1/22; G05D 1/0088; G05D 1/101; B64C 2201/027; B64C 2201/042; B64C 2201/108; B64C 2201/128; B64C 2201/146; B64C 2201/127; B64C 2201/145; G05D 1/0227; G05D 1/0246; B64C 39/024

(57) ABSTRACT

The modular delivery vehicle system provides vehicle delivery services realized through delivery driver control or through remote operator interface involving a control network to manage delivery vehicles, delivery drones and delivery robots to deliver payloads to various locations including no-fly zones. Accordingly, the delivery drones and delivery robots may comprise propellers for aerial delivery service, comprise drive wheels land based delivery service, or comprises a combination of thereof in order to navigate inside the delivery vehicle to attain payloads, and to navigate on streets, bike lanes, sidewalks, courtyards, or inside buildings, etc. to drop-off payloads or pick-up payloads. In various elements the delivery vehicles, delivery drones and delivery robots comprise robotic mechanisms to affix boxed payloads onto loading brackets or in compartments of delivery drones and delivery robots, or may use robotic arms and loading mechanisms to pick-up or to drop-off payloads.

### CROSS REFERENCED TO RELATED APPLICATIONS

A notice of issuance for a continuation in part patent application in reference to application Ser. No. 15/993,609, filed May 31, 2018; title: “Robot and Drone Array”.

### FIELD

The present invention relates to delivery vehicles, to airborne and land based delivery drones and to airborne and land based delivery robots controlled semi-autonomously, autonomously by a remote operator, a control network and method of operating same.

### BACKGROUND

Companies such as Amazon, Google, FedEx, UPS and DHL are expressing interest in utilizing fleets of one or more delivery one or more delivery drones and/or one or more delivery robots to deliver packages to consumers on an expedited basis from the time there is placed to the time the goods are delivered to a business or residence.

Regulatory and safety issues as well as the limited range of state of the art one or more delivery one or more delivery drones and/or one or more delivery robots providing delivery services. The Federal Aviation Administration (FAA) currently does not allow one or more delivery one or more delivery drones and/or one or more delivery robots to operate in the National Airspace System (NAS) without specific permissions known as Certificate of Waiver or Authorization (COAs) that are costly and time-consuming to obtain and furthermore are not guaranteed.

The idea of swarms of delivery drones taking off flying among neighborhoods in no-fly zones has raised concerns from regulators with permission from the FAA, the current flight duration of commercially available or suitable for delivery into neighborhoods does not allow delivery drone logistic networks to operate in no-fly areas.

To accommodate the limited range of today's delivery service providers would have to establish new distribution centers throughout neighborhoods at a cost that would negate any savings from utilizing peer delivery drones. In some cases, one or more delivery one or more delivery drones and delivery robots could fly from or drive to and from current distribution locations of companies such as Amazon using drones to reach a limited number of local delivery destinations but not in destination rural areas the delivery drones would not have sufficient battery range to return to the distribution center for collection and reuse.

Accordingly, what is needed are delivery vehicles and modular delivery drone and modular delivery robots having performance capabilities that overcomes the objections of regulators and the general public to reach an expanded geographical area by flying and/or by driving to delivery locations in urban and rural settings without or with airports.

### SUMMARY

In one or more elements modular delivery vehicle system offers delivery vehicles being manned operating semi-autonomously or unmanned operating autonomously, accordingly the present invention offers delivery vehicles that collaborate with delivery drones and with delivery robots which may use propellers for aerial delivery service or use drive wheels for land based delivery service, or use a combination of thereof allowing modular performance capabilities to navigate inside the delivery vehicle to attain payloads and to operated outside the vehicle to navigate on streets, bike lanes, sidewalks, courtyards, or inside buildings, etc. to drop-off payloads or pick-up payloads. More specifically, the delivery vehicles comprise robotic mechanisms to affix boxed payloads onto loading brackets or in compartments of delivery drones and delivery robots, and the delivery robots may use robotic arms and loading mechanisms to pick-up or to drop-off payloads. More particularly, the delivery drones and delivery robots may use a combination of sensors and cameras to detect payloads whilst operating inside the delivery vehicle, or when running at a delivery location the sensors ad cameras to detect threats, to delivery payloads, and to obtain payloads. More so, the modular delivery vehicle system may employ a control network to wirelessly communicate vehicle-to-everything messages and instructions for controlling the delivery vehicles, delivery drones and delivery robots to work in collaboration with respect to deploying one or more delivery drones and/or delivery robots to fly or to drive to consigned locations through generated GPS routes and then instruct them to return to the delivery vehicle for the next payload delivery assignment.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a graphic diagram of a Modular Delivery Vehicle System 400 working at a delivery location 404 setting in accordance with exemplary embodiments of the present invention.

FIG. 1A and FIG. 1AA are perspective views of a manned delivery vehicle 100A and employed delivery driver 401 loading packages in accordance with exemplary embodiments of the present invention.

FIG. 1B is a see-through view of the delivery vehicle 100B and FIG. 1BB shows a payload loading rail system 112 in accordance with exemplary embodiments of the present invention.

FIG. 2A, FIG. 2B and FIG. 2BB are perspective views of various delivery drones 200A comprising propellers for aerial logistic service 800A in accordance with exemplary embodiments of the present invention.

FIG. 2C, FIG. 2CC, FIG. 2D and FIG. 2DD are perspective views of various delivery drones 200B comprising propellers for aerial logistic service 800A and comprising drive wheels for land based logistic service 800B in accordance with exemplary embodiments of the present invention.

FIG. 3A, FIG. 3B and FIG. 3C and FIG. 3D are perspective views of various delivery robots 300B comprising drive wheels for land based logistic service 800B in accordance with exemplary embodiments of the present invention.

FIG. 3E and FIG. 3F are perspective views of various delivery robots 300B comprising drive wheels for land based logistic service 800B and comprising propellers for aerial logistic service 600A in accordance with exemplary embodiments of the present invention.

FIG. 3G is front view of delivery robot 300B comprising drive wheels for land based logistic service 800B and comprising propellers for aerial logistic service 600A in accordance with exemplary embodiments of the present invention.

FIG. 3H is a perspective view of a humanoid delivery robot 300D comprising drive wheels providing land based logistic service 800B and comprising propellers for aerial logistic service 600A in accordance with exemplary embodiments of the present invention.

FIG. 4A is a diagram exemplifying the modular delivery vehicle system 400 in accordance with exemplary embodiments of the present invention.

FIG. 4B is a flowchart exemplifying the control network 500 providing a drop-off delivery service 400A and/or pick-up delivery service 400B in accordance with exemplary embodiments of the present invention.

FIG. 5 is a flowchart exemplifying a Control Network 500 in accordance with exemplary embodiments of the present invention.

FIG. 6 is a flowchart exemplifying a robotic Payload Handling Process 600 in accordance with exemplary embodiments of the present invention.

FIG. 7 is a diagram exemplifying a Dispatch Management System 700 in accordance with exemplary embodiments of the present invention.

FIG. 8A is a flowchart exemplifying an Aerial Logistic Mode 800A in accordance with exemplary embodiments of the present invention.

FIG. 8B is a flowchart exemplifying a Land Based Logistic Mode 800B in accordance with exemplary embodiments of the present invention.

FIG. 9A are perspective views exemplifying a Battery Charging Processes 900A-900B in accordance with exemplary embodiments of the present invention.

FIG. 9B is a side view exemplifying a delivery robot 300CC that is aerial/land based 800A/800B autonomously docking on a battery charging station 901 of an autonomous vehicle 100B in accordance with exemplary embodiments of the present invention.

FIG. 10 is a perspective view exemplifying a Battery Switching Process 1000 in which the delivery driver places a battery pack into delivery drone/delivery robot in accordance with exemplary embodiments of the present invention.

FIG. 11 is a diagram exemplifying a Payload Pick-Up Process 1100 employing the delivery robot 300B and/or the delivery robot 300C to pick-up returns, or retrieve recyclable packages in accordance with exemplary embodiments of the present invention.

### DETAILED DESCRIPTION OF THE DRAWINGS

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

In various embodiment the delivery vehicle may be identified as “delivery vehicle 100”, “delivery vehicle 100A”, delivery vehicle 100B″, “delivery vehicles 100A-100B”.

In various embodiment the delivery drone may be identified as “delivery drone 200”, “delivery drones 200A”, delivery drone 200B″, “delivery drones 200A-200B”.

In various embodiment the delivery robot may be identified as “delivery robot 300”, “delivery robots 300A”, delivery robots 300B″, “delivery robots 300C”, “delivery robots 300CC”, “delivery robots 300D”, “delivery robots 300DD”, “delivery robots 300A-300D D”.

In various embodiment the payload may be identified as “payload 402”, “payload packages” or “boxes 108”, “parcel”, “cargo” or “goods”.

In various embodiment the delivery destinations may be identified as “business center delivery locations”, “neighborhoods”, and “no-fly areas”, “placement location”, “outside drop-off spot”, “entryway”, “inside a building”, “out a building”, “where a recipient 406 is waiting”, “recipient spot”, or other descriptions disclosed herein.

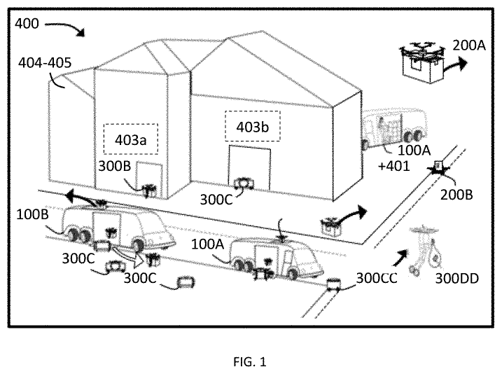

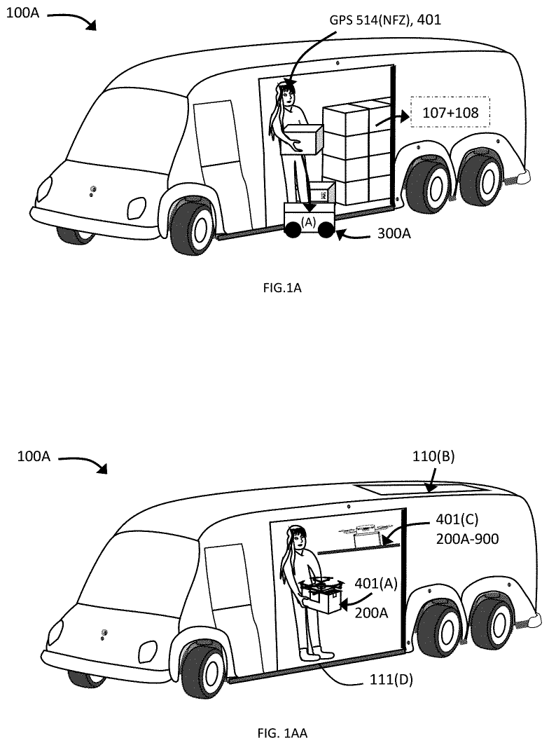

In greater detail FIG. 1 illustrates a Modular Delivery Vehicle System 400 working at a delivery location 404 setting, accordingly the modular delivery vehicle system 400 may employ various delivery drones 200A-200B and delivery robots 300A-300DD to actively deliver customers their payload 402, other settings may be a business center delivery location or a neighborhood areas, pretty much anyplace. Respectively, FIG. 1 shows some exemplary interactions between the delivery vehicles 100A-100B, delivery drones 200A-200B, delivery robots 300A-300DD.

Accordingly, the delivery drones 200A-200B and the delivery robots 300A-300DD are capable to handle a payload 402 with Payload Handling System 600 procedures 601-613, and then deliver payloads 403 to delivery destination 404. The delivery drones 200A-200B and the delivery robots 300A-300DD disembark from the delivery vehicle 100A-100B by Dispatch Management System 700 procedures 701-715 to go to delivery address, or go where a drop-off spot 405 is, or go where a recipient 406 is waiting as exampled by black arrows which indicate Aerial Logistic Mode 800A and indicate Land Based Logistic Mode 800B to travel on roads, sidewalks and bike lanes.

In accordance with a dispatch management system 700 delivery drones 200A-200B, delivery robots 300A-300DD are capable to pick-up payload 407 where a pick-up spot 408 is, as exampled, which may be to fly or to drive indoors or outdoors to access buildings, courtyards, rooftops, off road, etc.

In accordance with a dispatch management system 700 the various delivery drones 200A-200B and/or delivery robots 300A-300DD provide one or more instructions which may be fly or drive to work at buildings, arenas or work in space.

In accordance with a dispatch navigation system 700 the delivery vehicles 100A-100B are configured for receiving and transporting delivery drones 200A-200B, and delivery robot 300A-300D. Respectively delivery vehicles 100A are semi-autonomously configured and manned with a delivery driver 401, delivery vehicles 100B are autonomously configured to operate unmanned.

In accordance with GPS 415 provides a mapped route for a delivery destination 404 of the delivery vehicles 100A-100B each are configured for dispatching the delivery drones 200 and/or delivery robots 300A-300D from the delivery vehicle 100A-100B.

The control system 101 transmitting from the delivery vehicles 100 at least one of a GPS 415 providing a route map of a delivery location such as a business center, a neighborhood, or a multiplex structure 404 (illustrated) adjacent to other buildings.

The control network 500 transmitting a set of navigation instructions that are based on the GPS route map, to assist the delivery drone 200A-200B, delivery robot 300A-300DD travel to the payload 402 drop-off spot 405.

The delivery driver 401 or a remote operator 501 of the control network 500 may instruct the delivery drone 200A-200B, delivery robot 300A-300D from to disembark from the delivery vehicle 100A-100B (as exampled by black arrows) then proceed to the designated delivery addresses 403a -403b (i., e. dash line box).

The control system for the delivery drone 200A-200B and delivery robot 300A-300DD work in cooperation with the computer system of the delivery vehicle 100A-100B to handle payload delivery distribution associating with a control network 500.

In accordance with a dispatch navigation system 700 each delivery drone 200 and delivery robot 300 may be programmed for multiple distribution, the dispatch navigation system 700 may involve stages to go to a first address, then enter the building through the doorway, once inside then to drop-off their payload 402 they may be required to interact with a recipient 406 via a language library prompting them to retrieve their payload 402. Upon completion, the delivery drone/robot returns to the delivery to reload and to go to a second address, and so on, when all the delivery orders have been completed by the delivery drones 200 and/or delivery robots 300A-300D return to their delivery vehicle 100A-100B. Afterward, the delivery vehicle driver of delivery vehicle 100A returns to a nearby dispatch center or company associating the control network 500, then the delivery vehicle 100B is instructed by a remote operator 501 to another consignment job.

The fulfillment company provides a team of warehouse workers to load payload 402 (boxed 108) into a specific delivery vehicle 100 orders, the fulfillment company may use a control network 500 providing communication protocol which is detailed in FIG. 5 through FIG. 8B.

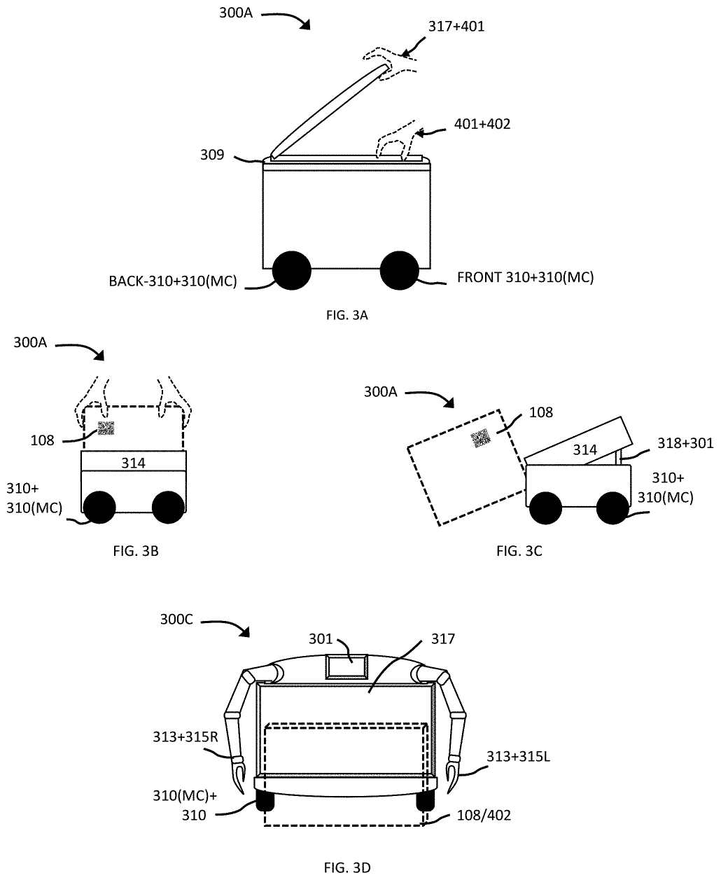

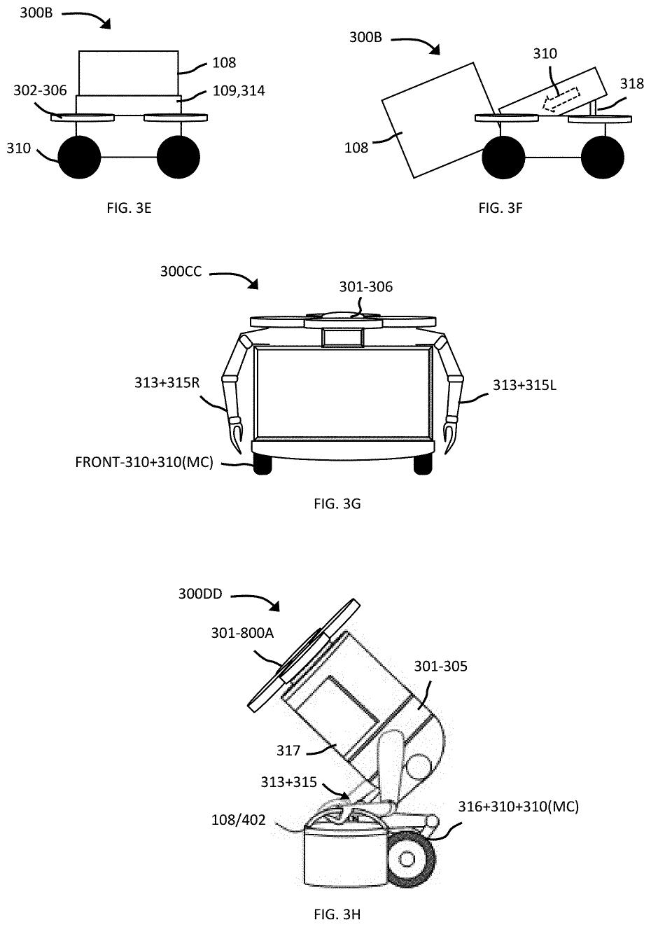

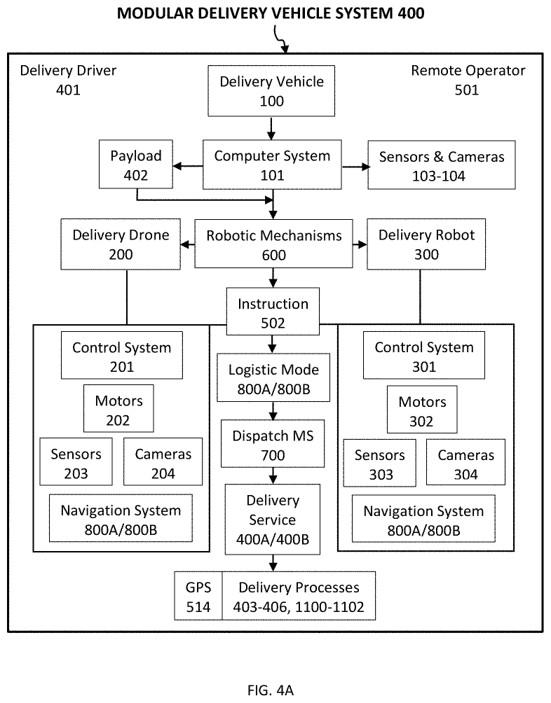

The remote operator 501 of delivery vehicle 100B providing instruction 502 502 502 for the delivery drone 200A-200B, delivery robot 300A-300D to navigate, the navigation may involve flying delivery service 400A to deliver the payload 402 to a drop-off spot 405, or driving delivery service 400B to deliver the payload 402 to a drop-off spot 405, or another delivery method may involve an action which is to dump the payload upon delivering the payload 402 on the spot, as exampled in FIG. 3C and FIG. 3D, accordingly other delivery payload scenarios are possible.

Additionally and alternatively delivery vehicles 100A-100B comprise a control system 101, a vehicle chassis 102, sensors 103, cameras 104, a battery bank 105, and a cargo hold section 106 for receiving a pallet 107 of boxes 108 and access openings including a roof hatch 109, automatic door 110 and a ramp 111, and may comprise a rail system 112, robotic arms 113, a loading latches 114 or a suction device 115.

Additionally and alternatively the delivery drones 200A-200B each comprise a control system 201, a fuselage 202 including propellers 218, sensors 203, cameras 204, a battery pack 205, and a cargo hold section 206 configured with a gripping actuator 216 or a cargo compartment 217.

Additionally and alternatively the delivery robots 300A-300DD each comprise a control system 301, a cart chassis 302 including drive wheels 319, sensors 303, cameras 304, a battery pack 305, and a cargo hold section 206 configured as a gripping actuator 316 or a cargo compartment 317.

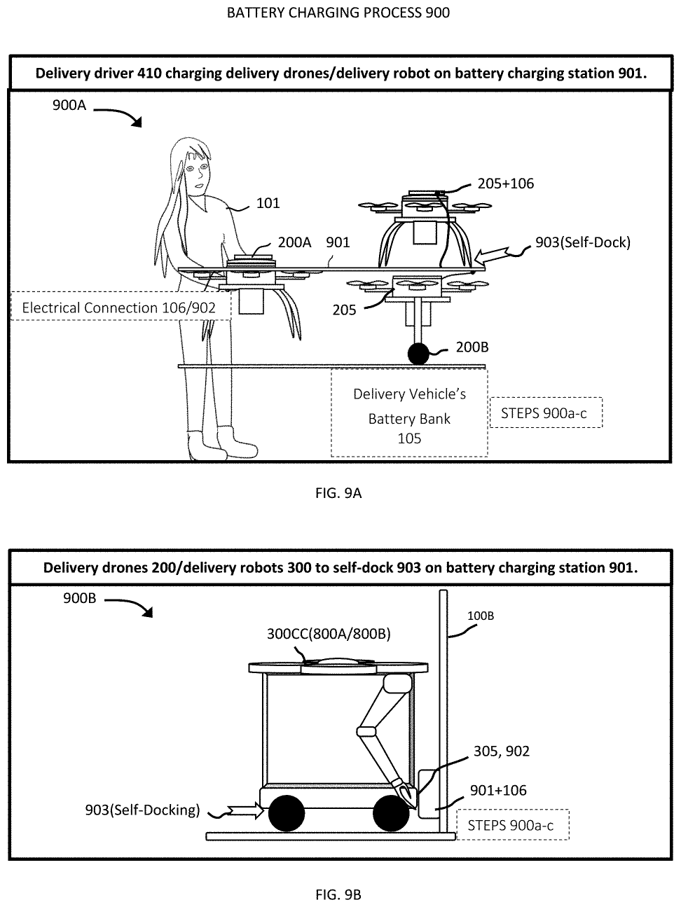

Accordingly the roof hatch 109, automatic door 110 and ramp 111 open automatically to receive one or more of delivery drones 200A-200B and delivery robot 300A-300D each being capable of autonomously self-dock on a battery charging station as example in FIG. 9B, accordingly by guidance of a combination of sensors 203/303 and cameras 204/304, the delivery drones 200A-200B and delivery robot 300A-300D each comprise control systems linking to a control network 500, wherein various operations are handled by the delivery driver 401, as shown the delivery driver 401 manually loads the delivery drones/delivery robots.

In greater detail FIG. 1A illustrates modular delivery vehicle system comprising a delivery vehicle 100A characterized as being manned operating semi-autonomously through delivery driver interface, the delivery vehicle 100A configured to transport one or more payload packages, delivery drones, delivery robots. Accordingly, a delivery driver 401 is employed to affix payloads on delivery drones and on delivery robots, or in an alternative loading procedure an automated package loading apparatus may be provided to assist the delivery driver for affixing payload packages on the delivery drones 200 and delivery robots 300 as well.

Respectively, wherein the delivery vehicle 100A is configured with operations handled by the delivery driver 401 whereby navigation is controlled semi-autonomously by the control system 101 when engaged by the delivery driver 401. The delivery vehicle 100A is configured with a combination of sensors 103 and cameras 104 for detecting object and threats during operation, and configured with GPS 514 providing route data destination in geographic areas, GPS 514 receives roadway traffic data of the geographic areas and establishes if there are no-fly zones GPS 514(NFZ), and determining, based on the roadway traffic data for driving to delivery destinations, as shown FIG. 1AA the delivery vehicle 100A operations are handled by the delivery driver 401 by manually however GPS 514 provides route data destination in no-fly zones GPS 514(NFZ), and determining, based on FAA zoning data.

Respectively, wherein the delivery drones comprising propellers for aerial delivery service and comprising drive wheels for land based delivery service and controlled through real-time adjustment of operation and positioning realized through a or control network generating remote operator interaction.

Respectively, wherein the delivery robots comprising drive wheels for land based delivery service only and controlled through real-time adjustment of operation and positioning realized through a or control network generating remote operator interaction; an autonomous control system wirelessly linked to or control network, wherein or control network providing a vehicle-to-vehicle communication to allow wirelessly communication between delivery drones and/or delivery robots; the control network providing instruction methodologies for instructing the delivery drones and/or the delivery robots to deliver its package to at least one delivery destination; the control network providing instruction methodologies for instructing the delivery drones and/or the delivery robots to return to the delivery vehicle.

The modular delivery vehicle system's delivery driver 401 is employed for dispatching the delivery vehicle 100A on a route in proximity of a GPS 415 delivery location; and/or the delivery driver 401 may dispatch the delivery vehicle on a first route of one or more deliver destinations, the dispatch to a second route in proximity of second delivery destinations, and so on.

Respectively, wherein the delivery driver may be employed to affix packages on the delivery drones by manual handling procedures, or the delivery driver to affix packages on the delivery robots by manual handling procedures.

Respectively, delivery driver of the delivery vehicle 100A may collect one or more delivery drones or delivery robots requiring assistance, or assist the one or more delivery drones or delivery robots with a battery charging or battery switching service.

Respectively, delivery driver of the delivery vehicle 100A provide one of: instruction methodologies for instructing the delivery drones and/or the delivery robots to deliver its package to at least one delivery destination; instruction methodologies to control motion of delivery vehicle, delivery drones and/or delivery robots to navigate on a route generated by GPS; controlling the delivery vehicle on a first route in proximity of a second GPS delivery location, and so on, or instruction methodologies to switch a flight plan to a drive plan, or vice versa, to switch a drive plan to a flight plan; generating GPS return route of delivery vehicle; instructing the delivery drones and/or the delivery robots to return to the delivery vehicle via GPS return route, or storing GPS route data to memory or cloud network.

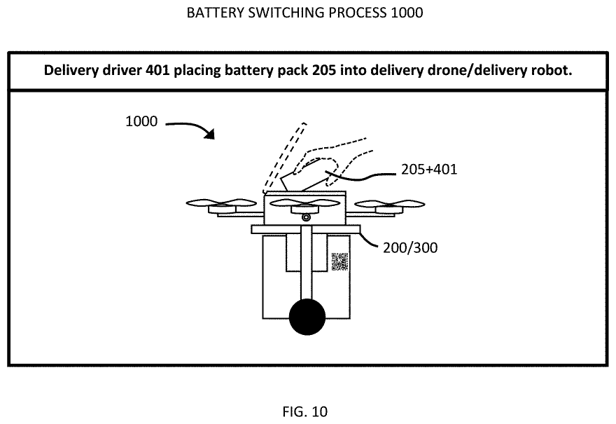

The delivery driver 401 may also assist the delivery drones or delivery robots by placing them on docking stations for charging as exampled by black arrow(C) by system 900 of FIG. 9A, or placing battery packs inside the delivery drones and/or the delivery robots by system of FIG. 10.

As shown in FIG. 1A a delivery driver 401 to take payload packages from the stack then place the payload 402 on the delivery robots 300 or on the delivery drones as examples in FIG. 1AA.

The delivery vehicle 100A is providing for no-fly zones GPS 514(NFZ), providing at least one access opening which may doors 110 and include automatic ramp 111 shown in FIG. 1B, allowing delivery drones 200 and delivery robots 300 to enter or to exit automatically, however no opened hatch 109.

The delivery vehicle characterized as being manned further comprising a remote operator of the delivery vehicle 100A may instruct the delivery driver 401 to collect impaired delivery drones 200/delivery robots 300 at the GPS location of an impaired delivery drone 200/delivery robot 300.

The remote operator 501 may dispatch the delivery vehicle 100A-100B on a first route destination 403a, then dispatch the delivery vehicle 100A-100B on a second route in proximity of second delivery destination 403b, 403c 403a -403b (i., e, dash line box), and so on.

In greater detail FIG. 1AA delivery vehicle 100A operations are handled by the delivery driver 401 in no-fly zones GPS 514(NFZ), as shown delivery driver 401 manually affixes the last payload 402 on the delivery drone 200A, respectively, as shown the delivery driver 401 manually gathers a packaged payload and then places the package between loading brackets 214 of the delivery drone 200A black arrow(A), or places the delivery drone 200 on a docking station of the delivery robot 300 between deliveries.

The control system 101 comprising at least one processor configured to automatically the hatch 110 to receive flying delivery drones and delivery robots to enter the delivery vehicle hatch 110 as shown by black arrow(B).

The delivery driver 401 may manually assist the delivery drones 200A-200B, delivery robots 300A-300D disembark from the delivery vehicle through an opened door 111 as exampled by black arrow(D) then disembark to travel to their delivery destination 403, other enter and exit scenarios are possible.

The control system 101 comprising at least one processor configured to access the at least one memory 103 and execute the computer-executable instruction to at least cooperate with the GPS 514 involving navigation system 600A/600B and the GPS 514 is to generate a route map of a terrain between the delivery vehicle 100A-100B and a payload 402 drop-off spot at a delivery destination 403, 415b, and a set of navigation instruction 502 502 that are based on the route map, to assist the delivery drones 200A-200B, delivery robots 300A-300D travel to delivery payload 402 drop-off spot at the delivery destination 404.

The control system 101 comprising at least one memory 103 that stores computer-executable instruction by at least one processor configured to access the at least one memory 103 and then to execute various instruction to at least cooperate with the GPS navigation 514 to generate a route map of a terrain between the delivery vehicle 100A and the delivery destination 403, and a set of navigation instruction that are based on the route map.

Additionally or alternatively, accurate GPS routes and schedules use route prediction with using Global Positioning System (GPS) data of the delivery vehicles 100, delivery drones 200, delivery robots 300 computing devices associated with a GPS-based navigation system. The delivery vehicles 100, delivery drones 200, delivery robots 300 may be designated to perform a task such as transporting payloads, goods, or the like. In some exemplary embodiments, the task performed by each of the delivery vehicles 100, delivery drones 200, delivery robots 300 to work in collaboration with each other to complete a delivery job.

The control system 101 associates with a control network 500 providing a communication module 504 which can enable communication to and from the delivery vehicle 100, including communication path can span and represent a variety of networks and network topologies. The control network 500 associated with a communication module which is to wirelessly communicate vehicle-to-everything messages pairing delivery vehicles with delivery drones and delivery robots, and the generating GPS delivery locations with respect to fly path planning or with respect to no-fly zones, or GPS to plan route for drive path, and store GPS route data.

For example, the communication path of delivery vehicle 100A can include wireless communication within, optical communication, ultrasonic communication, or the combination thereof. For example, satellite communication, cellular communication, Bluetooth connecting with the user terminal via Wi-Fi or Bluetooth RTM, Infrared Data Association standard (IrDA), wireless fidelity (WiFi), and worldwide interoperability for microwave access (WiMAX) are examples of wireless communication that can be included in the communication path. Cable, Ethernet, digital subscriber line (DSL), fiber optic lines, fiber to the home (FTTH), and plain old telephone service (POTS) are examples of wired communication that can be included in the communication path. Further, the communication path can traverse a number of network topologies and distances. For example, the communication path can include direct connection, personal area network (PAN), local area network (LAN), metropolitan area network (MAN), wide area network (WAN), or a combination thereof. The control system 101 can further execute the software for interaction with the communication path via the communication module 504.

The communication module 504 is wireless thus functioning as a communication hub allowing the delivery vehicle 100 to function as part of the communication path and not be limited to be an end point or terminal unit to the communication path can include active and passive components, such as microelectronics or an antenna.

The communication module 504 provides remote operator interface used for communication between the communication modules of the delivery drones 200/delivery robots 300 thus providing technologies and techniques that stores transmitted computer-executable instructions.

In greater detail FIG. 1B illustrates a delivery vehicle 100B characterized as being unmanned operating autonomously, accordingly the delivery vehicle 100B operating with instruction of a remote operator 501 which instructs various instruction for payload handling procedures of the autonomous delivery vehicle 100B, wherein the delivery vehicle 100B is configured to transport one or more packages, delivery drones 200, delivery robots 300.

Accordingly the rail system situated in a cargo hold section of the delivery vehicle, wherein the rail system including robotic arms configured with loading brackets or suction device for attaining payloads or affixing payloads, the rail system configured to affix packages on the delivery drones and on the delivery robots via preprogrammed instructions provided by a control system 101.

Accordingly the delivery drones comprising a control system, a communication module and propellers for aerial delivery service and comprising drive wheels for land based delivery service and controlled through real-time adjustment of operation and positioning realized through a or control network generating remote operator interaction, delivery robots comprising a control system 301, a communication module and drive wheels for land based delivery service only and controlled through real-time adjustment of operation and positioning realized through a control network generating remote operator interaction.

Accordingly the communication module linking the control system to a control network.

Accordingly the combination of sensors and cameras for detecting payloads, objects and threats.

Accordingly the GPS generating route data of delivery locations with respect to one of: preprogrammed GPS coordinates for flight navigation and path planning; preprogrammed GPS coordinates for drive navigation and path planning; preprogrammed GPS coordinates for flight navigation and/or drive navigation path planning in no-fly zones.

Accordingly the remote operator 501 of delivery vehicle 100B may provide one of: instruction methodologies for instructing the delivery drones and/or the delivery robots to deliver its package to at least one delivery destination; instruction methodologies to control motion of delivery vehicle, delivery drones and/or delivery robots to navigate on a route generated by GPS; controlling the delivery vehicle on a first route in proximity of a second GPS delivery location, and so on. And instruction methodologies to switch a flight plan to a drive plan, or vice versa, to switch a drive plan to a flight plan; generating GPS return route of delivery vehicle; instructing the delivery drones and/or the delivery robots to return to the delivery vehicle via GPS return route; storing GPS route data to memory or cloud network.

Accordingly the remote operator 501 instruction directed to delivery drones and/or delivery robots working inside a delivery vehicle 100B to complete various actions which may involve to self-dock to receive an electrical connection for charging process for a battery packs of the delivery drone and/or a battery pack of the delivery robot.

As shown in FIG. 18 wherein the control system 101, the sensors 103 and cameras 104 link to the control network 500. Wherein the delivery vehicle 100B providing at least one access opening which may include doors 110, ramps 111 or roof hatch 109 that is shown automatically opened 109(AO) allowing delivery drones 200 and delivery robots 300 to enter or to automatically exit trough an automatic door is shown automatically opened 110(AO), the ramp is shown automatically opened 111(AO), i., g. there can be other doors on both sides of the cargo hold section with ramps 111.

In various elements the delivery vehicles 100A-100B may utilize a package affixing method capable to mechanically move about respectively to attain at least one payload 402 such that the delivery drone/delivery robot can productively receive it.

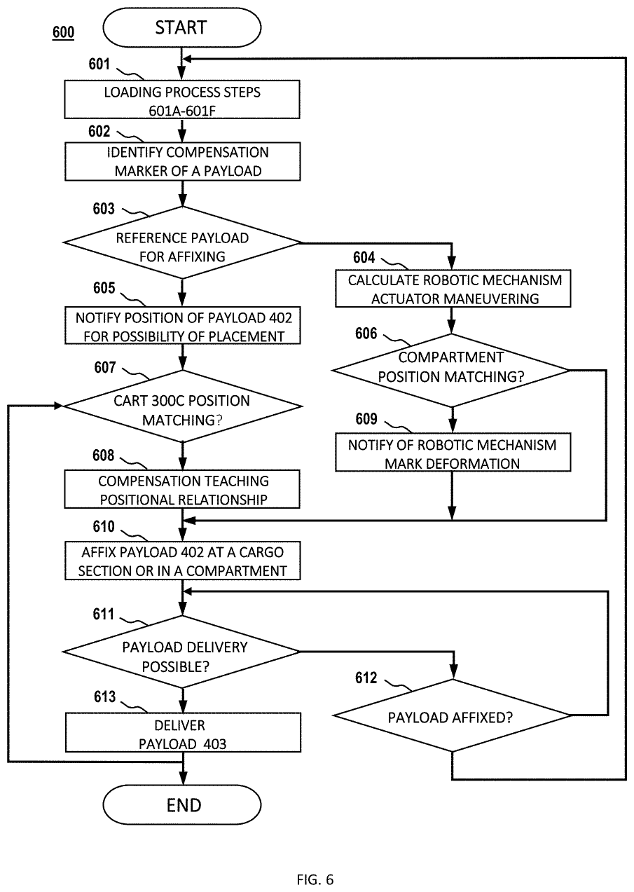

Accordingly, delivery vehicle 100B illustrates a rail system situated over or to side of a palletized payloads 402 loaded at preferred fulfillment company, wherein a package identification device includes an optical scanner or an RFID tag reader marker a step to identify a compensation marker 602 of a payload 402 as detailed in FIG. 6, then reference the payload 603 for affixing, then calculate the robotic mechanism actuator maneuvering, the package identification device configured to identify the packaged payload 404, wherein the package identification device is configured to communicate the package identification to the communication interface, wherein the communication interface is configured to utilize the package identification for a specific delivery location.

The delivery vehicle 100B in FIG. 1B illustrates a see-through view of rail system 112 comprising a package affixing method capable to mechanically move about respectively within the cargo hold section 106 containing palletized packaged payloads 402 as exampled being stacked. Wherein a built-in upper rail system 112 is provided, conceivably to perform maneuvering procedures demonstrated in the cargo hold section 106. Wherein the rail system 112 is configured with a robotic arm 113 comprising loading brackets 114 or comprising motorized actuators to grab a payload off of a stack of palletized boxes 107+108, then place the packaged payload at a cargo hold section of delivery drones 200A-200B and delivery robot 300B, 300CC, 300DD.

As shown in FIG. 1BB, shows the rail system 112 comprising a package affixing robotic arm 113 comprising a suction device 115 which robotically moves about to attain at least one payload 402 and to release the payload 402, wherein the suction device 115 gripping is achieved by hydraulic or pneumatic actuators is possible, either way the delivery drone/delivery robot receive a payload 108-402.

The delivery vehicle 100A-100B include a control system 101, the delivery drones 200A-200B include a control system 201, and delivery robot 300A-300DD include a control system 301, each system linked to a combination of sensors 103 and cameras 104 to monitor or execute operations or to perform tasks, and to handle a payload 402 and/or to deliver payloads 404 via a navigation system which may involve instructions to fly 801-809 or to drive 801-809 on a road or a sidewalk to deliver the payload 402 to a drop-off spot which is one of an entryway to a building 403a, inside a building 403b or a payload 406 location 403c.

The delivery vehicle 100, delivery drones 200A-200B and delivery robot 300A-300DD can include a combination of sensors 203-303 configured to obtain the sensor readings used to execute the tasks and operations, such as for manipulating the structural members. The sensor readings can include information or data obtained by the sensors signals or data of events or changes in the environment of the delivery vehicle 100, delivery drones 200A-200B and delivery robot 300A-300DD, and relays or sends the information to components of the delivery vehicle 100, external devices, or a combination thereof to facilitate the tasks. The sensor readings can include, for example, image readings, for example, a digital image or a point cloud/depth view. The sensor readings can further include quantified measures, for example, measures of forces, torques, rotations, speeds, distances, or a combination thereof.

The sensors 103 can include devices configured for detection or measurement of the sensor readings for example, the sensor can be configured to detect or measure one or more physical properties of the delivery vehicles 100A-100B, such as a state, a condition, a location of one or more structural members or joints, information about objects or a surrounding environment, or a combination thereof. As an example, the sensors can include various sensors including imaging devices like cameras, or a combination thereof.

In some embodiments, the sensors 103 can include one or more of the imaging devices or cameras 104 configured to capture, recognize, detect, or a combination thereof the surrounding environment of the delivery vehicles 100A-100B, delivery drones 200A-200B and delivery robot 300A-300DD. For example, the imaging devices can include two-dimensional (2D) cameras, three-dimensional (3D) cameras, both of which can include a combination of visual and infrared capabilities, lidars 103a, radars 103b, other distance-measuring devices, and other imaging devices. The imaging devices can generate a representation of the environment of the delivery vehicles 100A-100B, such as a digital image or a point cloud/depth view, used for implementing machine/computer vision for automatic inspection, navigation guidance, or other robotic applications.

In some embodiments, use a combination of sensors configured to monitor threats for example, the sensors 103 can include units or devices to detect and monitor positions of structural members, such as the robotic components and the end-effectors, corresponding joints of the robotic mechanisms. As a further example, the robotic system 100 can use the system sensors to track locations, orientations, or a combination thereof of the structural members and the joints during execution of the tasks.

In some embodiments the delivery vehicles 100, delivery robots 200, and delivery robots 300 may comprise a combination of sensors and cameras to detect payload loading operations within the delivery vehicle and sensors and cameras provided on a section of outside the delivery vehicle for detecting objects and to monitor activity or capture images, the sensor preferably being one of LIDAR, RADAR, tactile related, or other security system related, other examples of the sensors can include accelerometers 103c, gyroscopes 103d or IMUs for balance control, or position encoders 103e.

Other examples of the sensors can include contact sensors 103f, such as pressure sensors 103g, force sensors 103h, strain gauges 103i, piezoresistive/piezoelectric sensors 103j, capacitive sensors 103k, elastoresistivity sensors 103l, torque sensors 103m, linear force sensors 103n, or other tactile sensors 103o, configured to measure a characteristic associated with a direct contact between multiple physical structures or surfaces. The sensors configured to receive information from external sources, or can transmit information to other delivery vehicles 100 implemented with technologies and techniques of the control network 500.

Accordingly the camera provides images to reference positional relationship to identify compensation marks which may by one of M1, M2, M3 attached to the mechanical mechanism like the robotic arm 113, 213, 313 initially, teaching positional relationship which is the positional relationship between the delivery destination and the three compensation marks M1, M2, M3 to be taught, outcome of delivery of the payload with each mechanical mechanism, etc.

The reference positional relationship and the teaching positional relationship can be written in a format such as the absolute coordinates of the three compensation marks M1, M2, M3 and delivery destination in the coordinate system of the mechanical mechanism (hereinafter may be referred as package handling devices like robotic arms 113-313, loading brackets 114-314, grippers 215, dumpster 218, scooper 219) detailed herein.

The control system 101 providing camera images to the remote operator 501, the images including the three compensation marks M1, M2, M3 to be captured from different viewpoints in the camera 104, by causing the camera 104 to move by causing the posture of the robotic arm 113 to change. Data of images captured by the camera 104 is stored in the cargo loading section. Capturing of the three compensation marks M1, M2, M3 by the camera 104 may be performed in a state in which the package handling device stopped at a position adjacent to the mechanical mechanism, or may be performed while the loading brackets grabbing onto the boxed payload 402, as shown by arrow A.

The control system 101 calculates the relative positions of the three compensation marks M1, M2, M3 relative to the recipient address, i.e., the coordinates of the centers of each of the three compensation marks M1, M2, M3 in the coordinate system (hereinafter may be referred as local coordinate system) of the package handling device 400 with the ID as reference, based on the captured images of the camera 104. More specifically, the mark relative position calculation unit of the control system 101 can be configured so as to calculate relative positions of the three compensation marks M1, M2, M3 relative to the recipient address, i.e., coordinates in the local coordinate system, from the displacement of the three compensation marks M1, M2, M3 by the parallax of the captured images from different viewpoints of the camera 104.

The control system 101 calculates the oblateness of the three compensation marks M1, M2, M3 in the same image captured by the camera, respectively, and determines whether the oblateness of the three compensation marks M1, M2, M3 match. The mark deformation, in the case of the difference between the average value of oblateness of the three compensation marks M1, M2, M3 and the maximum value or minimum value being no more than a threshold set in advance, can be configured so as to determine that the oblateness of the three compensation marks M1, M2, M3 match.

The control system 101 calculates the posture of the robotic arm 113 arranging the boxes 108 at the delivery destination, based on the relative positions of the three compensation marks calculated by the mark relative position, and the teaching positional relationship taught in advance as the positional relationship between the three compensation marks and the cargo receiving position. More specifically, by converting the position of the mechanical mechanism to the local coordinate system of the package loading or unloading function calculated, and the posture of the robotic arm 113 which can position the packages 103 as calculated.

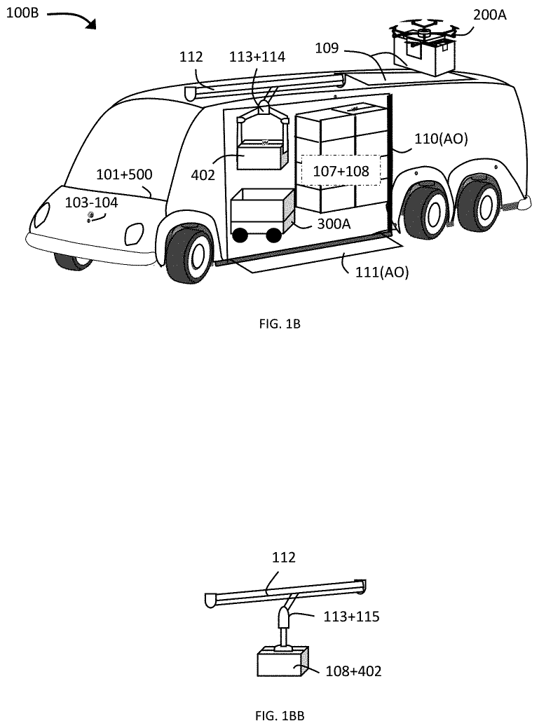

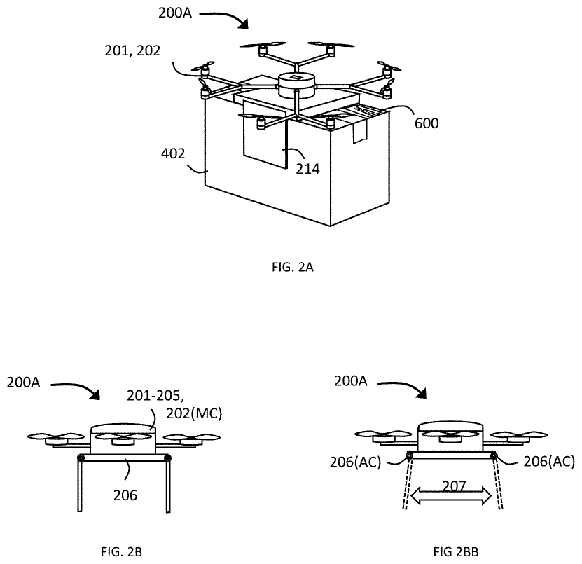

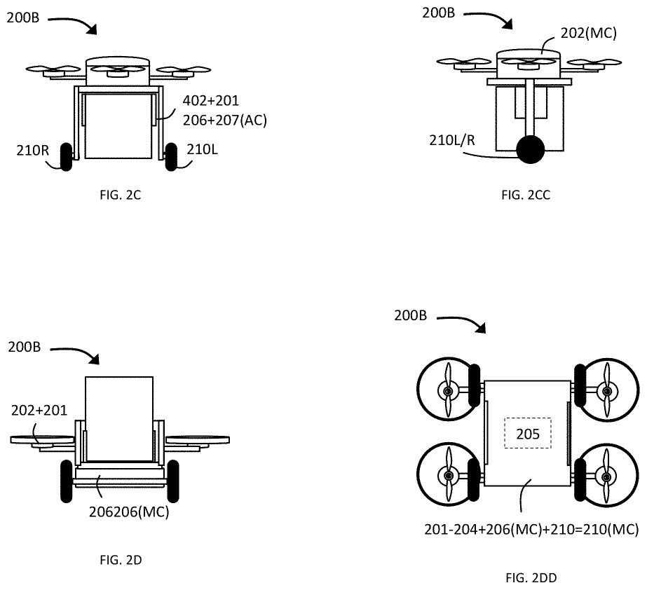

In greater detail FIG. 2A, FIG. 2B and FIG. 2BB illustrate the delivery drones 200A comprising a control system 201, propeller 202 with motor controller 202(MC), battery pack 205 configured with loading brackets 206 having actuator motor 206(AM) to grab and hold the boxed payload 108-402 (as example by arrow 207). Receptively, the propellers 202 delivery drones 200A are commonly configured for aerial delivery service 400A, the delivery drones 200A comprising propellers 202 for aerial logistic service 800A through the control system 201. In various elements the various delivery drones provide modular performance capabilities to navigate inside the delivery vehicle to attain payloads, more so operated outside the vehicle to navigate on streets, bike lanes, sidewalks, courtyards, or inside buildings, etc. to drop-off payloads or pick-up payloads. The delivery drones may use a combination of sensors and cameras to detect payloads, objects or threats with respect to delivery drones operating inside the delivery vehicle or when running at a delivery location.

In exemplary embodiments, the flying delivery drones 200 which are capable to self-dock accordingly by guidance of a combination of sensors 203 which monitor mechanical motion, and accordingly use various sensors 203 like altimeters, LIDAR, RADAR, gyros etc. to the detect objects and monitor the surroundings inside or outside the delivery vehicle 100, and have cameras 204 to capture images of a dropped-off payload at its destination.

In exemplary embodiments, the flying delivery drones 200 may be equipped with fasteners such as latches, push-to-connect fittings, bolts, straps or any combination thereof. The fasteners that can easily be undone to access the fuselage and thus the package being delivered.

In exemplary embodiments, the flying delivery drones 200 or flying delivery robots may be made of any suitable material such as plastic, metal, fiberglass or any combination thereof, and the battery pack 205 may be lithium (10-polymer batteries with an output of approximately 16. about 0.20 amps at 29.4V or higher approximate.

In exemplary embodiments, the flying delivery drones 200/delivery robots 300 the one or more propellers, thrusters, or other mechanics that allows the flying delivery drones 200 or flying delivery robots 300 maintain flight after take-off.

The aerial delivery drones 200A-200B/ and delivery robots 300A/300B may be equipped with a flight controller 800A linked to the propeller's motor controller 202(MC) designed to achieve one or more of 1) Gyro Stabilization via gyroscope sensor 203d—the ability to easily keep the propeller motion stable and level under the remote operator 501's control. This is a standard feature of all flight control boards; 2) Self Leveling—the ability to let go of the pitch and roll stick on the transmitter and have the propeller motion stay level; 3) Care Free—The remote operator 501 can control the propeller motion as if it is pointing in its original direction as the orientation of the propeller motion changes; 4) Altitude Hold—the ability to hover a certain distance from the ground without having to manually adjust the throttle; 5) Position Hold—the ability to hover at a specific location; 6) Return Home—the ability to automatically return to the point where the propeller motion initially took off; and 7) Waypoint Navigation—the ability to set specific points on a map that propeller motion will follow as part of a flight plan 800A. Exemplary flight controllers that are known in the art and may be used in the present invention include AeroQuad 32 by Carancho Engineering; the Crius All in One PRO; the Wookong by DJI Innovations; and the UAVXArm by QuadroUFO. These are simply illustrative examples as other flight controllers may also be used.

As discussed above, exemplary embodiments may further be equipped with one or more propellers, thrusters, motor controllers or other mechanics that allows the flying delivery drones or flying delivery robots discussed below, to take off and maintain flight.

In an exemplary embodiment the one or more delivery drones 200 or one or more delivery robots 300 may include brushless motors. 14.5 W 28,500 RPM, and motor controllers a Micro ball bearing, a Low noise Nylatron gears for 1/8.75 propeller reductor, a Tempered steel propeller shaft, a Self-lubricating bronze bearing, a Specific high propelled drag for great maneuverability, an 8 MIPS AVR CPU per motor controller, an Emergency stop controlled by software, a fully reprogrammable motor controller, and a Water resistant motor's electronic controller.

In an exemplary embodiment, quad-propeller motions as discussed earlier can be mounted in any orientation to the fixed-wing one or more delivery vehicles 100 such as up-side-down, because such one or more delivery one or more delivery drones 200A-200B are commonly equipped with GPS and inertial sensors 203 and are capable of determining and correcting platform attitude.

For example, one or more delivery drones 200 have fast-moving powered motors at which time their on-board inertial system will cause their propulsion system to right itself after which the one or more delivery drones 200A-200B will follow a pre-programmed route and descent profile in order to land at a desired delivery location. Alternately, the one or more delivery one or more delivery drones 200B may use a combination of rotors and/or motorized drive wheel 210 propulsion to guide themselves to the delivery location on land, as exampled in FIG. 1.

In greater detail FIG. 2C is a front view of a drone 200B which may be configured with one or more drive wheels 210, and FIG. 2CC is a side view of delivery drone 200B comprising propellers 202 for aerial logistic service 800A and comprising drive wheels 210 having motor controllers 210(MC) for land based logistic service 800B, wherein loading brackets 206 actuate exampled by white arrow 207 are used for delivering a boxed payload 108-402. Accordingly, the drive wheels 210 of delivery drone 200B may set RIGHT/LEFT and link to the motor controllers 210(MC), the drive wheel motors link to the control system 201 which receives signals and data from gyroscopes, IMUs or other sensor to control velocity, maintain balance and steering.

In greater detail FIG. 2D and FIG. 2DD illustrate the delivery drones 200B comprising propellers 202 for aerial logistic service 800A and comprising drive wheels 210 for land based logistic service 800B, whereby the drive wheels 210 are configured with motors providing fore and aft motion via motor controllers 210a linked to the control system 201, as exampled the drive wheels are placed FRONT/BACK or exampled as L/R. Wherein the delivery drone 200B is configured with a cargo compartment 208 or loading brackets 206, the delivery drones may obtain a payload by loading brackets 206 configured for holding the packaged payload via squeezing pressure applied 207 (white arrow) by actuator controllers 206(AC).

Respectively land-based navigation is accomplished by preprogrammed GPS coordinates 514, accordingly the delivery drones 200B also comprise sensors 203 to monitor mechanical mechanisms, the surroundings inside or outside the delivery drones 200B, utilize cameras 204 to capture images after dropping off the payload at the drop-off spot 405. Accordingly, the delivery robots 300A-300D may use a combination of sensors and cameras to navigate inside the delivery vehicle to attain payloads, more so to monitor operations outside the vehicle, and when navigating on streets, bike lanes, sidewalks, courtyards, or inside buildings, etc. to drop-off payloads or pick-up payloads.

Respectively the drive wheels 210 are configured with motors providing fore and aft motion via motor controllers 210(MC) linked to the control system 201 or controlled remotely by the control network 500.

In greater detail FIG. 3A, FIG. 3B and FIG. 3C and FIG. 3D illustrate the delivery robots 300A, 300B, 300C comprising a control system 301, drive wheel 310, battery pack 305 configured with loading brackets 314 to grab and hold a boxed payload 108/402. Respectively the drive wheels 310 are configured with motors controllers 310(MC) providing fore and aft motion via motor controllers 310(MC) linked to the control system 301 the drive wheels are placed FRONT/BACK or exampled as L/R. As shown FIG. 3A illustrates the delivery robot 300A comprising an opened compartment 309 to securely hold a boxed payload 108, The compartment of the delivery robot 300A is opened by the recipient or delivery driver 317+401 to unload/load the payload 108-402 therein. Accordingly the drive wheels 310 are set BACK/FRONT and link to the motor controllers 310(MC); FIG. 3B illustrates the delivery robot 300A comprising an opened compartment 309 to securely hold a boxed payload 108, the compartment is exampled as dumping out the boxed payload onto the ground by a dumping device 318; FIG. 3C illustrates the delivery robot 300C comprising a control system 301, sensors 303, cameras 304, propellers and robotic arms 313+315R/L, drive wheels 310 plus provided for FRONT-310+310(MC) supporting a boxed payload 108-402. The control system provides a communication module 504 which is to wirelessly communicate messages respect to instruction 502 for robotic mechanisms to affix a boxed payload 108-402 inside the cargo compartment 309 via an opened lid 317 or to dump the payload out, some methods are exampled loading processes 601-613, other maneuvering actions are achievable.

In exemplary embodiments, the battery pack 305 may include lithium (10-polymer batteries with an output of approximately 16. about 0.20 amps at 29.4V or higher approximate.

In exemplary embodiments, the delivery robots 300A, 300B, 300C are capable to self-dock accordingly by guidance of a combination of sensors 303 which monitor mechanical motion, and accordingly use various sensors 303 may include one of LIDAR, RADAR etc. to the detect objects and monitor the surroundings inside or outside the delivery vehicle 100, and have cameras 304 to capture images of a dropped-off payload at its destination.

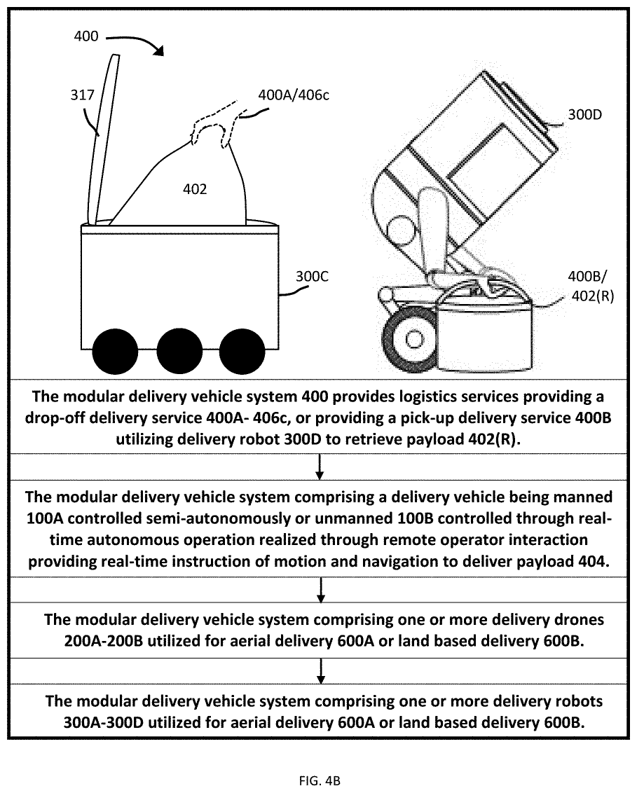

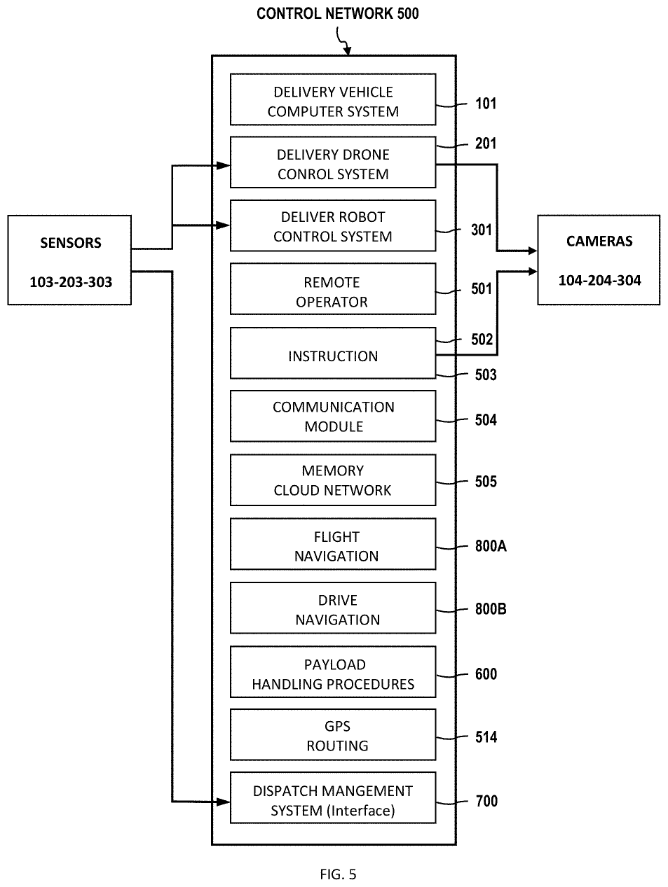

The communication module is to wirelessly communicate messages respect to peer to peer collaboration including delivery drones 200 and delivery robots 300 with the communication module 405 which is to wirelessly communicate messages respect to instruction 502 for robotic mechanisms to affix a payload 402 package at a delivery robot's cargo compartment 309, as exampled in FIG. 1 and FIG. 4B, or at loading brackets 206/314.

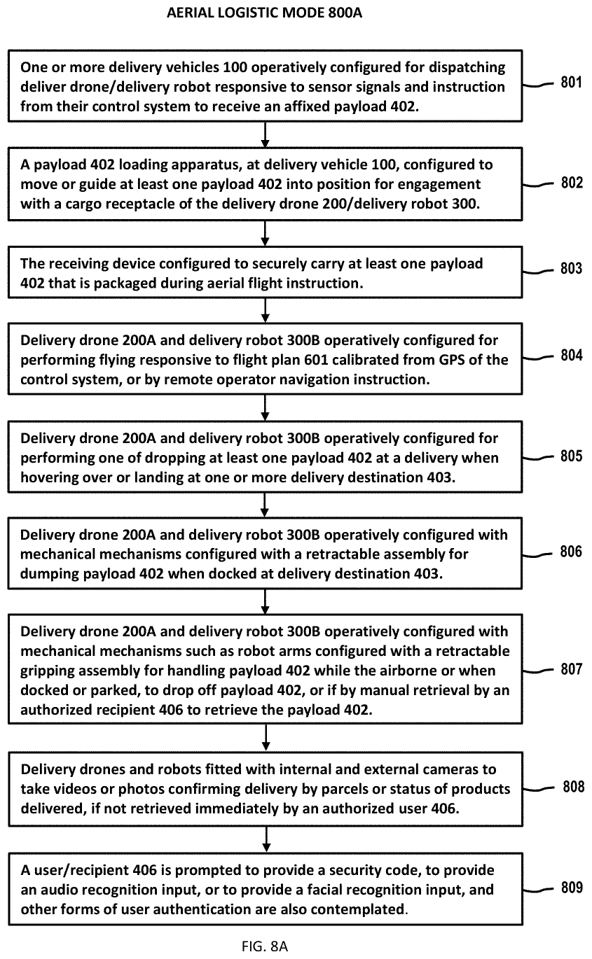

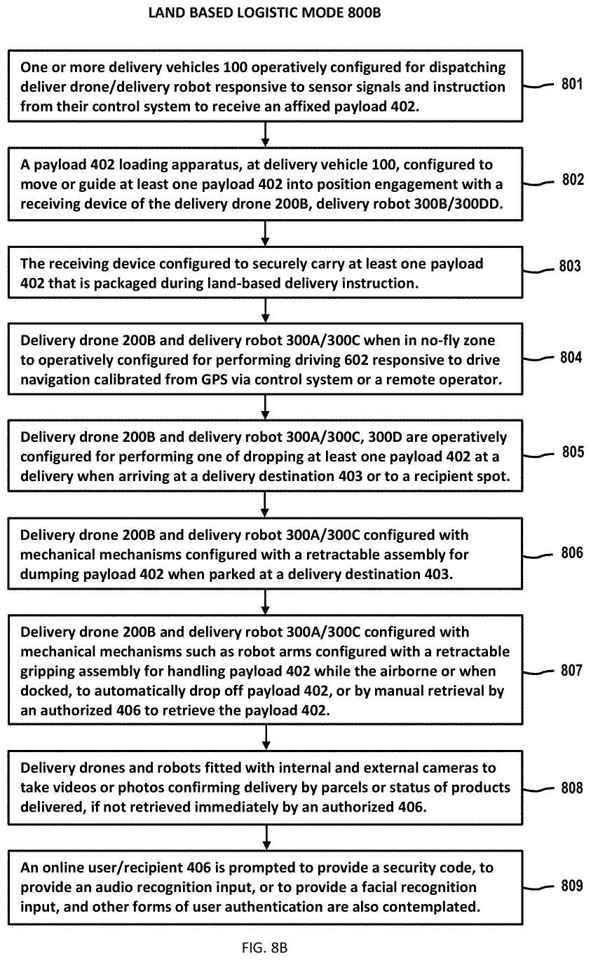

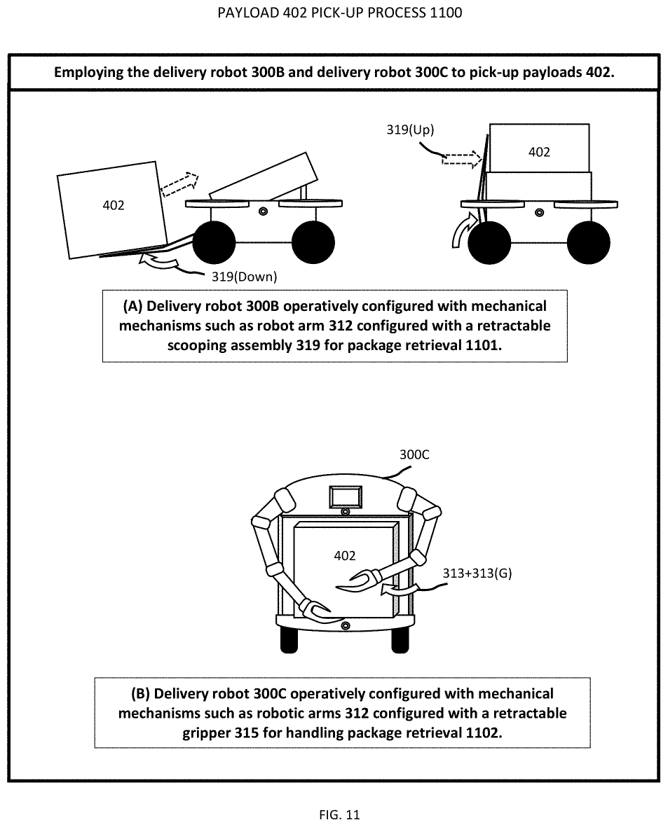

In greater detail FIG. 3E, FIG. 3F, and FIG. 3G illustrate the delivery robots 300B comprises drive wheels 310 for land based logistic service 800B and comprising propellers 302 for aerial logistic service 600A and navigation plans of FIGS. 8A/8B and FIG. 11. Accordingly as FIG. 3E illustrates the delivery robot 300B comprising an opened compartment 309 to securely hold a boxed payload 108; FIG. 3F illustrates the delivery robot 300B comprising an opened compartment 309 to securely hold a boxed payload 108, the compartment is exampled as dumping out the boxed payload onto the ground by a dumping device 318; As FIG. 3G illustrates the delivery robot 300CC comprising a control system 301, propellers 302, sensors 303, cameras 304, propellers and robotic arms 313+315R/L, drive wheels 310 plus provided for FRONT-310+310(MC) supporting a boxed payload 108. The control system provides a communication module 504 which is to wirelessly communicate messages respect to instruction 502 for robotic mechanisms to affix a boxed payload 108/402 inside the cargo compartment 309 or dump the payload, some methods are exampled loading processes 601-613, other maneuvering actions are achievable. Accordingly, the delivery robots 300B-300CC may use a combination of sensors and cameras to navigate inside the delivery vehicle to attain payloads, more so to monitor operations outside the vehicle, and when navigating on streets, bike lanes, sidewalks, courtyards, or inside buildings, etc. to drop-off payloads or pick-up payloads.

In greater detail FIG. 3H illustrates the humanoid delivery robot 300DD comprising drive wheels 310 providing land based logistic service 800B, as exampled in FIG. 4B and comprising propellers 302 for aerial logistic service 600A, and as exampled FIG. the delivery robot 300DD comprises humanoid characteristics, wherein a control system 301 is provided for controlling the propellers 302 and other motorized parts, the upper portion utilizes sensors 303, cameras 304, the mid-section comprises robotic arms 313+315R/L, each having grippers 315, the mid-section is configured with a compartment for housing a payload, the door 110 of the compartment 109 is opened to receive a payload inserted by the robotic arms 313, and the lower section comprises robotic legs 216 connecting to drive wheels 310/310(MC), the delivery robot 300DD is shown bending down the attain a payload 402. The humanoid delivery robot 300D, 300DD uses robotic arms 313 to access the payload loading and/or unloading section within the compartment 309. The control system provides a communication module 504 which is to wirelessly communicate messages respect to instruction 502 for robotic mechanisms to affix a boxed payload 108/402 inside the cargo compartment 309 with exampled loading process 601-613.

In various navigation procedures the humanoid delivery robot 300D comprising robotic legs 316 which attach to the drive wheel 310, whereby the drive wheels 310 are configured to drive over steers and sidewalks. Wherein both humanoid delivery robot 300D/300D is configured with a cargo compartment 309 the delivery robot 300DD may include robotic arms 313 to obtain a payload then maneuver the payload 402 into the cargo compartments 309 via grippers 315.

In various navigation procedures the humanoid delivery robot's drive wheels 310 allow differential drive mobility to park more particularly self-dock 320 accordingly by guidance of motor sensors 303 which monitor mechanical motion of the drive wheel 310 by a motor controller 310(MC), and may use a combination of sensors and cameras to navigate inside the delivery vehicle to attain payloads, more so to monitor operations outside the vehicle, and when navigating on streets, bike lanes, sidewalks, courtyards, or inside buildings, etc. to drop-off payloads or pick-up payloads.

In exemplary embodiments, a self-dock 903 process is achieved by guidance of a combination of sensors 303 which monitor mechanical motion, and accordingly use various sensors 303 may include one of LIDAR, RADAR etc. to the detect objects and monitor the surroundings inside or outside the delivery vehicle 100, and have cameras 304 to capture images of a dropped-off payload at its destination.

In various navigation procedures the delivery robots 300B, 300CC and humanoid delivery robot 300DD may be equipped with a flight controller designed to achieve one or more of 1) Gyro Stabilization via gyroscope sensor 303d—the ability to easily keep the propeller motion stable and level under the remote operator 501's control. Waypoint Navigation—the ability to set specific points on a map that propeller motion will follow as part of a similar flight plan of the delivery drones 200. As discussed above, exemplary embodiments may further be equipped with one or more propellers, thrusters, motor controllers or other mechanics that allows the flying delivery drones or flying delivery robots exampled above, to take off and maintain flight until landing at a delivery destination, or upon landing to switch to driving when entering a no-fly area.

As discussed above, mechanical mechanisms of the delivery drones 200 and the delivery robots 300 can include a method of operation including: receiving a sensor reading associated with a target object; generating a base plan for performing a task on the target object such as a package or boxed payload 402, wherein generating the base plan includes determining a grip point and one or more grip patterns associated with the grip point for gripping the target object based on a location of the grip point relative to a designated area, a task location, and another target object; implementing the base plan for performing the task by operating an actuation unit and one or more grippers 314 according to a grip pattern rank, to generate an established grip on the target object, wherein the established grip is at a grip pattern location associated with the grip patterns; measuring the established grip; comparing the established grip to a force threshold; and re-gripping the target object based on the established grip falling below the force threshold.

As discussed above, the robotic arm 313 configured with gripper 315 with joint motors/actuators to transfer a payload into or from a cargo container 309 to the ground or configured to pick-up a payload that packaged or not packaged, further details will be discussed below.

Accordingly the robotic arms 313 of the delivery robot 300C may be configured to open the upper lid 317/cover as exampled in FIG. 3A, the robotic arms 313 of the delivery robot 300CC with grippers 315 to open the access door 317 of the compartment 309, as exampled in FIG. 3D.

In various elements the cargo compartment 209/309 can additionally or alternately function to form an outer portion shell to protect the payload (e.g., packaged delivery goods, recycled boxes, etc.) during transport.

In various elements the cargo compartment 209/309 can include insulation or be uninsulated, include temperature conditioning (e.g., via heating and/or cooling systems) or be unconditioned (e.g., no onboard heating and/or cooling systems), be air-tight or not air-tight, include windows or not include windows (e.g., or otherwise not optically connected to the exterior), include an inceptor (or other remote operator 501 input mechanism) or not include an inceptor (or other remote operator 501 input mechanism), include cargo bays, include tiedowns, house a battery pack 205/305 or other power source, and/or include suitable plug-in AC adaptors.

As illustrated in FIG. 4B the land based humanoid delivery robot 300D comprising robotic legs 316 which attach to the drive wheel 310, land based only whereby, the drive wheels 310 are configured to drive over streets, bike lanes, or sidewalks. Wherein both humanoid delivery robot 300D-300D comprise robotic legs 316 which attach to the drive wheel 310, whereby the drive wheels 310 are configured with motors providing fore and aft motion via motor controllers 310(MC) linked to the control system 301.

Wherein both humanoid delivery robot 300D-300D are configured with a cargo compartment 309, the delivery robot 300DD may include robotic arms 313 to obtain a payload then maneuver the payload 402 into the cargo compartments 309.

In various navigation procedures the humanoid delivery robot 300D-300DD use various sensors 303 like LIDAR, RADAR, gyros etc. to the detect objects and monitor the surroundings inside or outside the delivery vehicle 100, and have cameras 304 to capture images of a dropped-off payload at its destination and pick-up payload or goods with the robotic arms 313 to obtain a payload then maneuver them into the cargo compartment 309 autonomously.

According to the afore mentioned delivery drones 200A-300B and the delivery robots 300A-300B use the communication module 504 is to wirelessly communicate messages respect to peer to peer collaboration with delivery robots 300D/300DD.

The control system of delivery robot 300D-300DD is programmed for various delivery processes in which a payload 402 can be dropped-off at the delivery destination 403.

In yet alternative embodiments, the communication module 504 generates control signals of the one or more delivery vehicles 100A-100B, delivery drones 200A-200B, delivery robots 300A-300DD. The control signals may be transmitted from the one or more delivery vehicles 100 to the one or more delivery one or more delivery drones 200A-200B and/or one or more delivery robots 300A-300DD through wirelessly interface connection. Each one or more delivery drones 200 and/or one or more delivery robots 300 and the one or more delivery vehicles 100 may be equipped with wireless transmission equipment including transmitter and receivers. In such exemplary embodiments, the one or more delivery vehicles 100 can govern the location and flight pattern of each one or more delivery drones 200/delivery robots 300. This can be helpful in the event the one or more delivery drones 200/delivery robots 300 also to return to the one or more delivery vehicles 100 after delivery as it can easily rendezvous with the one or more delivery vehicles 100. In exemplary embodiments, the one or more delivery vehicles 100 can track the location of the delivery drones 200/delivery robots 300 but not control their flight paths this function is managed by the following system elements.

In greater detail FIG. 4A illustrates a Modular Delivery Vehicle System 400 employed for logistic consignment jobs, the Modular Delivery Vehicle System 400 using one or more delivery vehicles 100A-100B each are configured for receiving and transporting one or more delivery drones 200A-200B and/or transporting one or more delivery robot 300A-300D. Accordingly, the Modular Delivery Vehicle System 400 is linked to the delivery vehicle's control system 101, the delivery drone's control system 201, the delivery robot's control system 301. Respectively delivery vehicles 100A work semi-autonomous and manned with a delivery driver 401, delivery vehicles 100B are autonomously configured to operate unmanned. The logistic consignment jobs can be fulfilled, and the delivery operations such as configured for receiving and transporting payloads are control by a control network 500 employing remote operators 501 to provide various instruction 502 to the control systems 101, 201, 301, systematically each control system receives instruction 502 from , and stores data in memory 502, and/or in cloud network 503, wherein a communication module 504 transmits data signals 503 from sensors 103, 203, 303, and image data 504 from cameras 104, 204, 304. The instruction 502 are calibrated by performance data 505 relating to navigation 506, motor control 507, steering 508, velocity 509, self-docking involving flight navigation 800A or drive navigation 800B calibrated by GPS 514 providing routing data 514a, and control network interface associating with a dispatch management system 700 disclosed herein.

In various elements, the Modular Delivery Vehicle System's control system provides instructions 502 to the one or more delivery vehicle's which are manned 100A controlled semi-autonomously, or unmanned 100B controlled through real-time autonomous operation realized through remote operator interaction providing real-time instruction of motion, positioning and navigation, if required, the delivery driver 401 or the remote operator 501 can manually/remotely control navigation activities and delivery activities to insure that the delivery drones 200 and the delivery robots 300 are successful to complete operations.

In exemplary embodiments, the one or more delivery vehicles 100 retains no control over the one or more delivery one or more delivery drones 200A-200B and/or one or more delivery robots 300A-300DD after dispatching them. Accordingly, the Modular Delivery Vehicle System provides instruction 502 to the one or more one or more delivery drones 200A-200B utilized for aerial delivery 600A or land based delivery 600B.

Accordingly, the Modular Delivery Vehicle System provides instruction 502 of the one or more one or more delivery robots 300A-300D utilized for aerial delivery 600A or land based delivery 600B.

In various examples, delivery destination 403 have a designated payload 402 drop-off spot which may be one of an entryway inside a building 405b.

In one delivery method, a payload 402 standing by for pick-up which is exampled in FIG. 3A and FIG. 3B, whereby the recipient 406 simply takes the (boxed) payload out of a cargo compartment 309 as FIG. 11 illustrates a tote being pulled out by hands.

Another delivery method may involve an action which is to dump the payload 402 on the spot, as exampled in FIG. 3C and FIG. 3D.

In alternative embodiments the control system for the delivery drone 200A-200B and delivery robot 300A-300D is programmed for various delivery processes in which a payload 402 can be dropped-off at the delivery destination 403.

In alternative embodiments the flight navigation 800A is provided to the one or more delivery one or more delivery drones 200A and/or one or more delivery robots 300B, 300CC, 300DD is autonomously controlled by a remote operator providing real-time instruction of motion, positioning and flight navigation 800A.

In alternative embodiments the drive navigation 800B is provided to the one or more delivery one or more delivery drones 200B and/or one or more delivery robots 300A, 300C, 300D when autonomously controlled by a remote operator providing real-time instruction of motion, positioning and drive navigation 800B.

In alternative embodiments the communication between one or more delivery drones 200A-200B, delivery robots 300A-300DD can be limited to simply tracking each other and thus potentially relay location of each other.

In alternative embodiments the one or more delivery drones 200A-200B, delivery robots 300A-300DD are controlled wirelessly through a remote operator 501 providing adjustments based on movements of the steering and velocity.

In alternative embodiments, the one or more delivery drones 200A-200B, delivery robots 300B, 300CC, 300DD can have the option to override the flight control or drive control to self-dock autonomously or by remote operator instruction 502 when entering the cargo hold section 106, as exampled in FIG. 9A.

In alternative embodiments, the one or more delivery drones 200A-200B, delivery robots 300B, 300CC, 300DD can have the option to override the flight control or drive control to self-dock autonomously or by remote operator instruction 502, as exampled in FIG. 9B.

The modular delivery vehicle system 400 is associated with the control network 500 and logistics services involving a drop-off delivery service 400A, or a pick-up delivery service 400B such as retrieval of packages, goods and other items.

In greater detail FIG. 4B illustrates the Control Network 500 providing a drop-off delivery service 400A delivery 406 and/or pick-up delivery service 400B. The modular delivery vehicle system 400 provides logistics services providing a drop-off delivery service 400-406, or providing a pick-up delivery service 400B utilizing delivery drones 200 and delivery robots 300 to retrieve payload 402(R). The modular delivery vehicle system 400 providing a manned delivery vehicle 100A controlled semi-autonomously with delivery driver 401 to control of vehicle navigation, or the modular delivery vehicle system 400 providing an unmanned delivery vehicle 100B controlled through real-time autonomous operation realized through remote operator interaction providing real-time instruction 502 via a remote operator to virtually control motion and navigation to attain/receive payloads and deliver payloads 404. The modular delivery vehicle system further providing one or more delivery drones 200A-200B and/or delivery robots 300A-300DD utilized for aerial delivery 600A, utilized for land based delivery 600B or utilized for a combination thereof, respectively.

In greater detail FIG. 5 illustrates the Control Network 500 providing a Payload Handling Process 600 and a Dispatch Management System 700 initiating various instruction which may involve instruction 502 to delivery drones and/or delivery robots to mechanically perform various payload handling maneuvers or docking maneuvers when working inside the delivery vehicle, and to receive a payload 402 affixed by delivery driver 401 of the manned delivery vehicle, providing instruction 502 to delivery drones and/or delivery robots to autonomously obtain a payload 402 via a payload handling procedure of the unmanned delivery vehicle, or providing instruction 502 to delivery drones and/or delivery robots to exit from the delivery vehicle via flight procedure or driving procedure, providing instruction 502 to delivery drones and/or delivery robots to enter or exit the delivery vehicle via flight procedures or via driving procedures, and providing instruction 502 to delivery drones and/or delivery robots to receive an electrical connection where the battery pack 205/305 is charged.

The remote operator 501 providing instruction 502 to the delivery vehicle 100 to drive to a first deliver destination 403, when the job is completed, the remote operator 501 providing instruction 502 to the delivery vehicle 100 to drive to a second delivery destination 403, and so on; the delivery drones 200 to dispatch to a first route at least one deliver destinations 403, then to deliver payload 404 to at least one delivery destination 403; and/or the delivery robots to dispatch to a first route at least one deliver destination 403, then to deliver payload 404 to at least one delivery destination 403 to deliver payload 404.

In greater detail FIG. 6 illustrates robotic Payload Handling Process 600 protocol may involve the following steps 601 are loading process steps 601A-601F; a step to identify a compensation marker 602 of a payload 402, then reference the payload 402/603 for affixing, then calculate the robotic mechanism actuator maneuvering 604 into a position to attain a payload, notify the position 605 of the payload 402, compartment position 606 matching, Yes 607, compensation teaching positional relationship 608, notify robotic mechanism to mark deformation 609 to affix payload 610 at a cargo section 207/307 or compartment 308, was delivery possible 611, if YES 612, deliver payload 613.

According Payload Handling Process 600 achieved by various robotic mechanisms which may be configured as a robotic arm 113 having grabbing device 116/600(A) or loading brackets 113/600(B) as exampled in FIG. 2A, or plausibly a suction device, or other package grabbing devices are possible.

Accordingly, a schematic operation in which the payload handling procedure 601 may apply the following loading process steps 601A-601F involving; 601A a robotic arm 113 with sensors and grabbing device is programmed to identify and obtain a specific payload label described as a compensation marker 602 which is achieved by scanning the palletized packages that are boxed or bagged in a bin; 601B the mechanical w/grabbing device is programmed to move about a track to position over a specific payload 402; 601C the grabbing device wedges in-between stacked packages and picks-up a specific package; 601D the mechanical arm situates the package directly over the delivery robot's payload compartment; 601D the grabbing device releases the package the delivery robot's payload compartment receives the payload; 601F the robotic arm 113 repositions to repeat the loading process again, these steps are repeated as the delivery robot arrives and departs the delivery vehicle 1006.

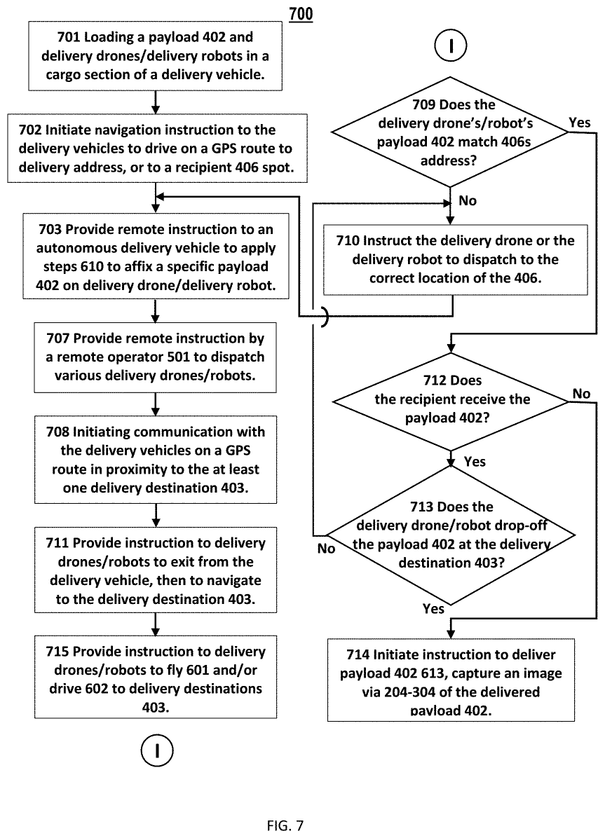

In greater detail FIG. 7 illustrates the Dispatch Management System 700 in which instruction 502 may involve the following steps: 701 Loading a payload 402 and delivery drones/delivery robots inside a cargo section of a delivery vehicle 100; 702 Initiate navigation instruction 502 to the delivery vehicles to drive on a GPS route to delivery address, or to a recipient 406 spot; 703 Provide remote instruction 502 to an autonomous delivery vehicle to apply steps 610 to affix a specific payload 402 on delivery drone/delivery robot; 707 Provide remote instruction 502 by a remote operator 501 to dispatch various delivery drones/robots; 708 Initiating communication with the delivery vehicles on a GPS route in proximity to the at least one delivery destination 403; 709 Does the delivery drone's/robot's payload 402 match 406s address? 710 Instruct the delivery drone or the delivery robot to dispatch to the correct location of the 406; 711 Provide instruction 502 to delivery drones/robots to exit from the delivery vehicle, then to navigate to the delivery destination 403; 712 Does the recipient receive the payload 402? 713 Does the delivery drone/robot drop-off the payload 402 at the delivery destination 403? 714 Initiate instruction 502 to deliver payload 402, then capture an image via 204-304 of the delivered payload 402; 715 Provide instruction 502 to delivery drones/robots to fly 601 and/or drive 602 to delivery destinations 403.

In greater detail FIG. 8A illustrates the Aerial Logistic Mode 800A providing procedures 801-809 in which instruction 502 may involve the following steps: 801 One or more delivery vehicles 100 operatively configured for dispatching deliver drone/delivery robot responsive to sensor signals and instruction 502 from their control system to receive an affixed payload 402; 802 A payload 402 loading apparatus, at delivery vehicle 100, configured to move or guide at least one payload 402 into position for engagement with a cargo receptacle of the delivery drone 200/delivery robot 300; 803 The receiving device configured to securely carry at least one payload 402 that is packaged during aerial flight instruction; 804 Delivery drone 200A and delivery robot 300B operatively configured for performing flying responsive to flight plan 601 calibrated from GPS of the control system, or by remote operator navigation instruction; 805 Delivery drone 200A and delivery robot 300B operatively configured for performing one of dropping at least one payload 402 at a delivery when hovering over or landing at one or more delivery destination 403; 806 Delivery drone 200A and delivery robot 300B operatively configured with mechanical mechanisms configured with a retractable assembly for dumping payload 402 when docked at delivery destination 403; 807 Delivery drone 200A and delivery robot 300B operatively configured with mechanical mechanisms such as robot arms configured with a retractable gripping assembly for handling payload 402 while the airborne or when docked or parked, to drop off payload 402, or if by manual retrieval by an authorized 406 to retrieve the payload 402; 808 Delivery drones and robots fitted with internal and external cameras to take videos or photos confirming delivery by parcels or status of products delivered, if not retrieved immediately by an authorized user 406; 809 A user/recipient 406 is prompted to provide a security code, to provide an audio recognition input, or to provide a facial recognition input, and other forms of user authentication are also contemplated.

In greater detail FIG. 8B illustrates the Land Based Logistic Mode 800B providing procedures 801-809 in which instruction 502 may involve the following steps: 801 One or more delivery vehicles 100 operatively configured for dispatching deliver drone/delivery robot responsive to sensor signals and instruction 502 from their control system to receive an affixed payload 402; 802 A payload 402 loading apparatus, at delivery vehicle 100, configured to move or guide at least one payload 402 into position engagement with a receiving device of the delivery drone 200B, delivery robot 3006/300DD; 803 The receiving device configured to securely carry at least one payload 402 that is packaged during land-based delivery instruction 502; 804 Delivery drone 200B and delivery robot 300A/300C when in no-fly zone to operatively configured for performing driving 602 responsive to drive navigation calibrated from GPS via control system or a remote operator instruction 502; 805 Delivery drone 200B and delivery robot 300A/300C, 300D are operatively configured for performing one of dropping at least one payload 402 at a delivery when arriving at a delivery destination 403 or to a recipient spot; 806 Delivery drone 200B and delivery robot 300A/300C configured with mechanical mechanisms configured with a retractable assembly for dumping payload 402 when parked at a delivery destination 403; 807 Delivery drone 200B and delivery robot 300A/300C configured with mechanical mechanisms such as robot arms configured with a retractable gripping assembly for handling payload 402 while the airborne or when docked, to automatically drop off payload 402, or by manual retrieval by an authorized 406 to retrieve the payload 402; 808 Delivery drones and robots fitted with internal and external cameras to take videos or photos confirming delivery by parcels or status of products delivered, if not retrieved immediately by an authorized 406; 809 An online user/recipient 406 is prompted to provide a security code, to provide an audio recognition input, or to provide a facial recognition input, and other forms of user authentication are also contemplated.

In greater detail FIG. 9A illustrates the Battery Charging Processes 900A-900B accordingly the battery charging system 901 provides steps a-c for charging a battery pack 205/305, comprising: a) a delivery vehicle battery bank 105 configured to power the docking station 901 during a portable operation to charge a battery pack 205/305; b) a recharging circuit for providing, in a battery charging system 900 recharge operation, the battery charging system 900 with sufficient charge for powering the portable operation to charge the battery pack 205/305, the recharging circuit comprising: a power input for receiving power during the battery charging system 900 recharge operation of the battery charging system 900; and a protector coupled between the power input and the electrical connection 106 of the battery back 105, the protector configured to protect the battery charging system 900 during the battery charging system 900 recharge operation; c) a charging module coupled to the battery charging system 900 and configured to receive power from the battery charging system 900 to charge the battery pack 205/305 in a battery charge operation as part of the portable operation.

In greater detail FIG. 9B illustrates the delivery drones and delivery robots autonomously docking on a battery charging station 901 further comprising: the battery charge control circuit configured to provide charging control of the battery pack 205/305 during the battery charge operation; and the battery charging status monitor coupled to the battery charge control circuit, the drone battery charging status monitor being configured to control operation of the battery charge control circuit based on a battery pack 205/305 status; and d) a battery connector 902 configured to connect the battery pack 205/305 upon a connection between the delivery drone 200/delivery robot 300a nd the charger port which may provide a wired charging means or wireless charging means via the battery connector 902 of the docking station 901. Respectively the delivery drone 200/delivery robot 300 can autonomously self-dock by driving or by flying when utilizing a combination of sensors and cameras successful to connect to the docking station to receive a battery charging connection, however if required, the delivery driver 401 or the remote operator 501 can manually/remotely control navigation activities and docking activities within the delivery vehicle to insure that the delivery drones 200 and the delivery robots 300 are successful to receive an electrical battery charging connection via wireless means or mechanical means as shown by cords.

In various elements the remote operator to then provide navigation instruction 502 to the one or more delivery drones and/or one or more delivery robots to autonomously attach to the docking station 901, respectively by self-docking 903, whereby the remote operator to then provide navigation instruction 502, by flying or by driving, for navigating the one or more delivery drones and/or one or more delivery robots to attach to a portion the battery connector 902 to receive a charging process.

In various elements the remote operator to then instructed the one or more delivery drones and/or one or more delivery robots to receive an electrical charge from the connection of the battery connector 902, respectively.

In various elements the remote operator may provide charging service to the delivery drones and the delivery robots and may provide retrieval action if needed, or may include collecting the delivery drone by the operator, after collecting, the one or more delivery drones, then dispatching the delivery vehicle on a second route in proximity of a second delivery destination, and so on.

In greater detail FIG. 10 illustrates the Battery Switching Process 1000 in which the delivery driver 401 places a battery pack 205/305 into delivery drone/delivery robot 1001. In various elements the delivery driver 401 places one or more battery packs 205/305 inside the battery compartment as shown by hands 1001 of the delivery driver 401, the battery packs are then attached to a battery connector 902 therein, respectively.

In greater detail FIG. 11 illustrates the Payload Pick-Up Process 1100 conceivably the upper drawing (A) shows the delivery robot 300B to retrieve a payload 1101, as shown a robotic lever assembled with a scooper mechanism 318 is scooping up the payload box 302. Conceivably the lower drawing (B) shows the delivery robot 300C operatively configured with robotic arms 313 configured with a gripper 314 for handling package retrieval 1102 whereby the package or boxed payload 402 is handled on a location of the grip point relative to one or more grippers 314 and mechanical motion generated by actuators may use the following process steps.

steps of a method or algorithm described in connection with the aspects disclosed herein may be embodied directly in hardware, in a software module executed by a processor, or in a combination of the two. A software module (e.g., including executable instruction 502 and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor 501 can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some respects any suitable computer-program product may comprise a computer-readable medium comprising codes (e.g., executable by at least one computer) relating to one or more of the aspects of the disclosure. In some respects, a computer program product may comprise packaging materials.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims.

aim,:

1. A modular delivery vehicle system comprising:
delivery vehicles characterized as semiautonomous or autonomous, wherein the delivery vehicle comprising an electric motorized system or other motorized system providing propulsion, a battery bank for auxiliary power and a control system for the management thereof;
a plethora of payloads received in a cargo hold section of the delivery vehicle, respectively payloads to be delivered by airborne delivery services or by land based delivery services achieved by various delivery drones and/or delivery robots;
the delivery drones and/or delivery robots characterized as semiautonomous or autonomous comprising an electric motorized system or other motorized system providing propulsion, a battery pack for auxiliary power and a control system for the management thereof;
a control system configured for controlling modular mechanical mechanisms attached therein to achieve operations involving receiving a payload at a cargo hold section and releasing the payload upon delivery;
various delivery vehicles collaborate with delivery drones and/or delivery robots may use propellers for aerial delivery service, or use drive wheels for land based delivery service, or use a combination of thereof allowing modular performance capabilities to navigate inside the delivery vehicle to attain payloads, or operated outside the vehicle to navigate on streets, bike lanes, sidewalks, courtyards, or inside buildings to drop-off payloads or pick-up payloads;
the delivery vehicles, delivery drones and delivery robots comprise robotic mechanisms to affix boxed payloads onto loading brackets or in compartments of delivery drones and delivery robots, or may use robotic arms and loading mechanisms to pick-up or to drop-off payloads;
the delivery drones and delivery robots use a combination of sensors and cameras to detect payloads, objects or threats with respect to delivery drones and/or delivery robots when operating inside the delivery vehicle or when running at a delivery location;
wherein the delivery drones comprising propellers for achieving aerial delivery service, or may comprise propellers for aerial delivery service and drive wheels for land base delivery service in which the control system instructing the delivery drone to switch from an aerial flight plan to a topography drive plan, respectively;
wherein the delivery robots comprising drive wheels for achieving land base delivery service, or may comprise drive wheels for land base delivery service and propellers for aerial delivery service, in which the control system instructing the delivery robot to switch an aerial flight plan to a topography drive plan in, respectively;
a control network wirelessly communicating vehicle-to-everything messages pairing delivery vehicles with delivery drones and delivery robots to work in collaboration;
the remote operator interface to control motion or positioning of a delivery operation of the delivery vehicles, delivery drones, delivery robots during a running procedures performed indoors or outdoors which may involve receive an affixed payload, or discharge a payload;
the remote operator interface to generates GPS routes in respect to at least deploying delivery drones and/or delivery robots to a delivery location and plan routes to return to the back to the delivery vehicle for next delivery assignment;
GPS generating delivery routes with respect to fly path planning, with respect to drive paths, with respect to no-fly zones, with respect to a return route for turning to a delivery vehicle.

2. The modular delivery vehicle system of claim 1 in which the delivery vehicles being manned operating semi-autonomously through delivery driver interface interaction providing real-time instruction of motion, positioning and navigation, if required, the delivery driver can manually or remotely control navigation activities and delivery activities to insure that delivery drones and delivery robots are successful to complete a delivery operation.

3. The modular delivery vehicle system of claim 1 in which the delivery vehicles being unmanned operating autonomously through a control network and remote operator interface to manage vehicle motion, navigation, positioning, or manage operations for affixing payloads onto delivery drones and/or delivery robots.

4. The modular delivery vehicle system of claim 1 in which the delivery drone further comprising:
propellers for aerial delivery service or propellers and drive wheels allowing the delivery drone fly or drive for aerial delivery service and/or land based delivery service which allows the delivery drone to navigate inside or outside the delivery vehicle;
sensors and cameras provided on a section of the delivery drone, the delivery robot to detect a specific payload or for detecting objects and to monitor activity or capture images, the sensor preferably being one of LIDAR, RADAR, or tactile related;
a control system associated with navigating the delivery drone during running maneuvers;
the control system of a delivery drone configured comply to remote operator instruction which may involve one of:
instructing the delivery drone to obtain an affixed payload;
instructing the delivery drone to deliver the payload to its delivery destination via a predetermined GPS route;
generating GPS route for an aerial flight plan;
generating GPS route for a topography drive plan;
instructing the delivery drone to switch an aerial flight plan to a topography drive plan in order to deliver a payload in a no-fly zone;
generating GPS return route;
instructing the delivery drone to return to the delivery vehicle via GPS return route, and/or storing GPS data.

5. The modular delivery vehicle system of claim 1 in which the delivery robot further comprising:
drive wheels for land based delivery service or drive wheels and propellers allowing the delivery robot to drive or fly for land based delivery service and/or aerial delivery service which allows the delivery robot to navigate inside or outside the delivery vehicle;
sensors and cameras provided on a section of the delivery drone, the delivery robot to detect a specific payload or for detecting objects and to monitor activity or capture images, the sensor preferably being one of LIDAR, RADAR, or tactile related;
a control system associated with navigating the delivery robot during running maneuvers;
the control system of a delivery robot configured comply to remote operator instruction which may involve one of:
instructing the delivery robot to obtain an affixed payload;
instructing the delivery robot to deliver the payload to its delivery destination via a predetermined GPS route;
generating GPS route for an aerial flight plan;
generating GPS route for a topography drive plan;
instructing the delivery robot to switch an aerial flight plan to a topography drive plan in order to deliver a payload in a no-fly zone;
generating GPS return route;
instructing the delivery drone to return to the delivery vehicle via GPS return route, and/or storing GPS route data.

6. The modular delivery vehicle system of claim 1 in which the control network associated with a communication module which is to wirelessly communicate vehicle-to-everything messages pairing delivery vehicles with delivery drones and delivery robots to work in collaboration.

7. The modular delivery vehicle system of claim 1 in which the delivery drones and/or delivery robots configured for one of; to receive a payload, to drop-off a payload, to pick-up a payload, or a combination thereof.

8. The modular delivery vehicle system of claim 1 in which the delivery drones and/or delivery robots configured for one of:
receiving a payload at loading brackets on delivery drones or delivery robots; or placing a payload in compartments of delivery drones or delivery robots.

9. The modular delivery vehicle system of claim 1 in which the delivery vehicle and delivery drone and/or delivery robot being configured to collaborate a loading maneuver to affix a payload at loading brackets or in compartments of delivery drones or delivery robots.

10. The modular delivery vehicle system of claim 1 in which the delivery vehicle further comprising a combination of sensors and cameras to detect payload loading operations within the delivery vehicle and sensors and cameras provided on a section of outside the delivery vehicle for detecting objects and to monitor activity or capture images, the sensor preferably being one of LIDAR, RADAR, tactile related, or other security system related, or a camera may provide images to reference positional relationship to identify compensation marks with resect to payload identification.

11. The modular delivery vehicle system of claim 1 in which the combination of sensors and cameras configured to monitor activity with respect to delivery drones and/or delivery robots when entering the delivery vehicle or when exiting the delivery vehicle via hatches or doors, or configured to monitor activity with respect to delivery drones and/or delivery robots when running at a delivery location, or to capture images of a delivered payload.

12. A modular delivery vehicle system comprising:
delivery vehicles characterized as being manned operating semi-autonomously through delivery driver interface, the delivery vehicle configured to transport one or more packages, delivery drones, delivery robots;
a delivery driver to affix a payload on delivery drones and on delivery robots, or provide an automated package loading apparatus is provided for affixing packages on the delivery drones and robots automatically;
the delivery drones comprising propellers for aerial delivery service and comprising drive wheels for land based delivery service and controlled through real-time adjustment of operation and positioning realized through a or control network generating remote operator interaction;
the delivery robots comprising drive wheels for land based delivery service only and controlled through real-time adjustment of operation and positioning realized through a or control network generating remote operator interaction;
wherein the control system configured for controlling modular mechanical mechanisms attached therein to achieve operations involving receiving a payload at a cargo hold section and releasing the payload upon delivery;
wherein the control system wirelessly linked to or control network, wherein or control network providing a vehicle-to-vehicle communication to allow wirelessly communication between delivery drones and/or delivery robots;
the control network providing instruction methodologies for instructing the delivery drones and/or the delivery robots to deliver its payload to at least one delivery destination;
the control network providing instruction methodologies for instructing the delivery drones and/or the delivery robots to return to the delivery vehicle.

13. The modular delivery vehicle system of claim 12 in which the delivery vehicle comprising a delivery driver providing action involving one of:
dispatching the delivery vehicle on a route in proximity of a GPS delivery location; and/or
provide a dispatch management system for the delivery driver to dispatch the delivery vehicle on a first route of one or more deliver destinations, the dispatch to a second route in proximity of second delivery destinations, and so on;
the delivery driver to affix a payload on the delivery drones by manual handling procedures;
the delivery driver to affix a payload on the delivery robots by manual handling procedures.

14. The modular delivery vehicle system of claim 12 in which the delivery vehicle comprising a delivery driver providing an action involving one of: collecting one or more delivery drones or delivery robots requiring assistance; assisting the one or more delivery drones or delivery robots with a battery charging or battery switching service.

15. The modular delivery vehicle system of claim 12 in which the delivery vehicle comprising a delivery driver providing at least one of:
affix a payload on a delivery drone;
affix a payload on a delivery robot;
assist the delivery drone to exit the delivery vehicle;
assist the delivery robot to exit the delivery vehicle;
controlling navigation of the delivery vehicle on a first route;
when instructed, controlling navigation of the delivery vehicle on a second route upon completing delivery jobs of the first GPS delivery route, and so on.

16. A modular delivery vehicle system comprising:
a delivery vehicle characterized as being unmanned operating autonomously, wherein the delivery vehicle configured to transport one or more payloads, delivery drones, delivery robots;
a rail system situated in a cargo hold section of the delivery vehicle, wherein the rail system including robotic arms configured with loading brackets or suction device for attaining payloads or affixing payloads, the rail system configured to affix a payload on the delivery drones and on the delivery robots via preprogrammed instructions provided by a control system;
delivery drones comprising a control system, a communication module and propellers for aerial delivery service and comprising drive wheels for land based delivery service and controlled through real-time adjustment of operation and positioning realized through a or control network generating remote operator interaction;
delivery robots comprising a control system, a communication module and drive wheels for land based delivery service only and controlled through real-time adjustment of operation and positioning realized through a control network generating remote operator interaction;
the communication module linking the control system to a control network;
wherein the control system configured for controlling modular mechanical mechanisms attached therein to achieve operations involving receiving a payload at a cargo hold section and releasing the payload upon delivery;
a dispatch management system involving GPS providing routes for consignment;
a combination of sensors and cameras for detecting object and threats.

17. The modular delivery vehicle system of claim 12, claim 16 in which the GPS generating route data of delivery locations with respect to at least one of: preprogrammed GPS coordinates for flight navigation and path planning or preprogrammed GPS coordinates for drive navigation and path planning, or provide a dispatch management system for flight navigation and/or drive navigation path planning in no-fly zones.

18. The modular delivery vehicle system of claim 1 and claim 16 in which the delivery vehicle characterized as being unmanned further comprising a remote operator providing at least one of:
instruction methodologies for instructing the delivery drones and/or the delivery robots to deliver its package to at least one delivery destination;
instruction methodologies to control motion of delivery vehicle, delivery drones and/or delivery robots to navigate on a route generated by GPS;
controlling the delivery vehicle on a first route in proximity of a second GPS delivery location, and so on;
provide a dispatch management system for instruction to switch a flight plan to a drive plan, or vice versa, to switch a drive plan to a flight plan;
generating GPS return route of delivery vehicle;
instructing the delivery drones and/or the delivery robots to return to the delivery vehicle via GPS return route;
storing GPS route data to memory or cloud network.

19. The modular delivery vehicle system of claim 16 in which the instruction directed to delivery drones and/or delivery robots working inside a delivery vehicle to complete various actions which may involve a procedure to self-dock on a docking station to receive an electrical connection, or may involve a procedure to receive an automatic charging process for charging a battery pack.

20. The modular delivery vehicle system of claim 1, claim 12, claim 16 in which the delivery drones and/or delivery robots working to complete maneuvering actions involving at least one of:
entering a delivery vehicle by flying through an opened hatch;
exiting the delivery vehicle by flying through an opened hatch;
entering the delivery vehicle by driving on a ramp;
exiting the delivery vehicle by driving on a ramp;
entering the delivery vehicle by flying through an opened door;
exiting the delivery vehicle by flying through an opened door.
